(19) United States
(12) Patent Application Publication
(10) Pub. No.: US 2012/0253868 A1
(43) Pub. Date: Oct. 4, 2012

(54) HEALTHCARE INFORMATION COMMUNICATION SYSTEM

(75) Inventors: Chip W. Ach, Sudbury, MA (US); Tobias Hauner, Brookline, MA (US); Molly A. Lorenzo, Allston, MA (US); Cal Pierog, Cambridge, MA (US); Kathryn A. Rodden, Waltham, MA (US); Libby C. Webb, Somerville, MA (US)

(73) Assignee: athenahealth, Inc., Watertown, MA (US)

(21) Appl. No.: 13/493,866

(22) Filed: Jun. 11, 2012

Related U.S. Application Data
(63) Continuation-in-part of application No. 13/165,147, filed on Jun. 21, 2011.
(60) Provisional application No. 61/357,014, filed on Jun. 21, 2010.

(51) Int. Cl. G06Q 10/06

(52) U.S. Cl. 705/7.12

(57) ABSTRACT

A healthcare information communication system is configured to facilitate scheduling of patient appointments without sending information to the medical practice indicating preferred appointment times. The system searches a current schedule for appointments at the medical practice for available timeslots to schedule an appointment. The current schedule is stored by a scheduling component of a practice management system. In response to receiving a selection of an available timeslot to schedule the appointment, the current schedule for appointments at the medical practice is updated in real-time without intervention from staff at the medical practice. An administrator at the medical practice may configure aspects of the scheduling component to customize appointment scheduling for one or more departments and/or providers at the medical practice. The system stores scheduling configuration information associating appointment types with schedule timeslots and the scheduling configuration information may be used in the determination of available timeslots when scheduling an appointment.

### RELATED APPLICATIONS

This application is a continuation-in-part of U.S. patent application Ser. No. 13/165,147, filed Jun. 21, 2011, which claims the benefit of U.S. Provisional Patent Application Ser. No. 61/357,014, filed Jun. 21, 2010.

The entire contents of application Ser. No. 13/165,147 and provisional application Ser. No. 61/357,014, are hereby incorporated by reference.

### BACKGROUND

In modern healthcare systems, medical practices typically communicate with patients for a variety of reasons including appointment scheduling, appointment reminders, billing reminders, and transmission of lab test results, among others. Despite the rise in popularity of alternative communication methods (e.g., email, text messaging, etc.), the vast majority of communications between medical practices and patients typically occur through conventional communication channels such as telephone calls initiated by staff at the medical practice or by paper communication sent via facsimile or through the mail.

To assist in the management of billing, some medical practices may contract with a third party which provides a practice management system that operates to reduce the amount of resources expended by the medical practice in managing such information. For example, the practice management system may facilitate and track the status of claims submitted to a multitude of healthcare payers chosen by patients of the medical practice. The practice management system may be a network-based system that enables billing personnel at a medical practice to view the status of claims submitted to a patient's healthcare payer to determine if and when remittance for the claims is received. If remittance is not received, the billing personnel may investigate the situation further to determine a reason for the denial of the claims so that additional steps may be taken to ensure that the claims are paid.

Some practice management systems may also manage electronic health information for patients of a medical practice. For example, information related to patient visits, lab results, current medications, among other things, may be stored by the practice management system and this information may be made available to physicians or other staff at a medical practice though a network-based system in order to facilitate patient care.

### SUMMARY

Applicants have recognized and appreciated that scheduling appointments for patients at a medical practice may be improved by providing an integrated healthcare information communication system that reduces the burden placed on staff of a medical practice imposed by conventional scheduling systems. To this end, some embodiments of the invention are directed to leveraging information stored in a practice management system to facilitate patient scheduling to enable the medical practice to focus on better management of patient care.

Some embodiments are directed to a method of scheduling an appointment for a first patient of a medical practice associated with a practice management system. The method comprises receiving a request from the first patient of the medical practice to schedule the appointment; searching a current schedule for appointments at the medical practice for available timeslots to schedule the appointment, wherein the current schedule is stored by a scheduling component of the practice management system; presenting on a user interface, the available timeslots returned from the search; receiving a selection of one of the available timeslots; and updating, with at least one processor, the current schedule for appointments at the medical practice in response to receiving the selection of one of the available timeslots

Some embodiments are directed to a computer system including at least one server computer configured to host a practice management system. The practice management system comprises: a scheduling component, wherein the scheduling component is configured to store a current schedule for scheduling appointments at a medical practice, wherein the current schedule is associated with a plurality of appointment attributes configured by an administrator at the medical practice; and at least one processor programmed to provide a web-based user interface, wherein the web-based user interface is configured to enable a first patient of the medical practice to schedule an appointment at the medical practice without sending information to the medical practice indicating preferred appointment times.

Some embodiments are directed to at least one computer-readable medium encoded with a plurality of instructions that, when executed by a computer, perform a method of scheduling an appointment for a first patient of a medical practice associated with a practice management system. The method comprises receiving a request from the first patient of the medical practice to schedule the appointment; searching a current schedule for appointments at the medical practice for available timeslots to schedule the appointment, wherein the current schedule is stored by a scheduling component of the practice management system; presenting on a user interface, the available timeslots returned from the search; receiving a selection of one of the available timeslots; and updating the current schedule for appointments at the medical practice in response to receiving the selection of one of the available timeslots.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a practice management system in accordance with some embodiments of the invention;

FIG. 2 is a block diagram of a communications management component in accordance with some embodiments of the invention;

FIG. 3 is a block diagram of an automated messaging service in accordance with some embodiments of the invention;

FIG. 4 is a sign-in page for a web portal in accordance with some embodiments of the invention;

FIG. 5 is a home page for a web portal in accordance with some embodiments of the invention;

FIG. 6 is an educational information page for a web portal in accordance with some embodiments of the invention;

FIG. 7 is a profile page for a web portal in accordance with some embodiments of the invention;

FIG. 8 is a medical record page for a web portal in accordance with some embodiments of the invention;

FIG. 9 is a messages page for a web portal in accordance with some embodiments of the invention;

FIG. 10 is a lab result page for a web portal in accordance with some embodiments of the invention;

FIG. 11 is an appointments page for a web portal in accordance with some embodiments of the invention;

FIG. 12 is an appointments request page for a web portal in accordance with some embodiments of the invention;

FIG. 13 is a billing page for a web portal in accordance with some embodiments of the invention;

FIG. 14 is an alternate view of the billing page shown in FIG. 13;

FIG. 15 is a credit card payment page for a web portal in accordance with some embodiments of the invention;

FIG. 16 is a medical form page for a web portal in accordance with some embodiments of the invention;

FIG. 17 is an alternate view of the profile page shown in FIG. 7;

FIG. 18 is a frequently asked questions page for a web portal in accordance with some embodiments of the invention;

FIG. 19 is a portion of a user interface displaying an inbox in accordance with some embodiments of the invention;

FIG. 20 is a portion of a user interface displaying an appointment request in accordance with some embodiments of the invention;

FIG. 21 is a portion of a user interface displaying a review page in accordance with some embodiments of the invention;

FIG. 22 is a portion of a user interface displaying an exemplary report generated by a practice management system in accordance with some embodiments of the invention;

FIG. 23 is a portion of a user interface displaying a department configuration page in accordance with some embodiments of the invention;

FIG. 24 is a portion of a user interface displaying third-party account management page in accordance with some embodiments of the invention;

FIG. 25 is a portion of a user interface displaying an administrative page in accordance with some embodiments of the invention;

FIG. 26 is a portion of a user interface displaying a test results page in accordance with some embodiments of the invention;

FIG. 27 is a portion of a user interface displaying a template storage page in accordance with some embodiments of the invention;

FIG. 28 is a portion of a user interface displaying a messaging preferences page in accordance with some embodiments of the invention;

FIG. 29 is a portion of a user interface displaying an appointment request page configured for use by a live operator in accordance with some embodiments of the invention;

FIG. 30 is a portion of a user interface displaying a patient case page configured for use by a live operator in accordance with some embodiments of the invention;

FIG. 31 is a portion of a user interface displaying a patient case review page in accordance with some embodiments of the invention;

FIG. 32 is a portion of a user interface displaying a patient registration page in accordance with some embodiments of the invention;

FIG. 33 is a portion of a user interface displaying search page configured to search for previous actions performed using a practice management system in accordance with some embodiments of the invention;

FIG. 34 is a portion of a user interface displaying billing administration page in accordance with some embodiments of the invention;

FIG. 35 is a portion of a user interface displaying a report generation page in accordance with some embodiments of the invention;

FIG. 36 is a portion of a user interface displaying a report library page in accordance with some embodiments of the invention;

FIG. 37 is a portion of a user interface displaying medical practice preferences page in accordance with some embodiments of the invention;

FIG. 38 is a portion of a user interface displaying an automated message scripting page in accordance with some embodiments of the invention;

FIG. 39 is a portion of a user interface displaying a task assignment configuration page in accordance with some embodiments of the invention;

FIG. 40 is a schematic of a network environment in which some embodiments of the invention may be employed;

FIG. 41 is a portion of a user interface for creating an operator protocol in accordance with some embodiments of the invention;

FIG. 42 is a portion of a user interface displaying an operator protocol page in accordance with some embodiments of the invention;

FIG. 43 is a portion of a user interface displaying a dashboard page for a web portal in accordance with some embodiments of the invention;

FIG. 44 is a portion of a user interface displaying a scheduled appointments page in accordance with some embodiments of the invention;

FIG. 45 is a portion of a user interface displaying an interactive scheduling calendar in accordance with some embodiments of the invention;

FIG. 46 is a flow chart of an exemplary process for scheduling an appointment in accordance with some embodiments of the invention;

FIG. 47 is a flow chart of an exemplary process for creating an appointment type in accordance with some embodiments of the invention;

FIG. 48 is a portion of a user interface displaying an appointment type configuration page in accordance with some embodiments of the invention;

FIG. 49 is a portion of a user interface displaying a new appointment type page in accordance with some embodiments of the invention; and

FIG. 50 is a portion of a user interface displaying a report page indicating appointments associated with a medical practice in accordance with some embodiments of the invention.

### DETAILED DESCRIPTION

The present disclosure generally relates to inventive methods and apparatus for facilitating communication of information between a medical practice and patients, and more specifically relates to leveraging information in a practice management system to automate at least some of such communication. Interaction with out-of-office patients is often a time-consuming yet important function of staff at a medical practice. Patients often schedule appointments at a medical practice months in advance of the appointment due to the busy schedules of physicians at the medical practice. To help reduce the possibility of a no-show, medical practice staff may call the patient a week or so before the appointment to remind the patient of the appointment. If the patient does not answer their phone when the staff member calls, several iterations of reminders may ensue until the patient can be reached. Alternatively, the patient's schedule may have changed and they may need to reschedule the appointment. However, on any one day, a medical practice may receive hundreds of such communications, further complicating the scheduling process. For example, if the patient is put on hold for a long time, the patient may become impatient and hang up, and the entire process may need to be repeated or the patient may simply not show up at the medical practice without informing the medical practice prior to their scheduled appointment. To this end, some embodiments of the invention are directed to alleviating at least some of the difficulties with conventional patient communication systems by facilitating both practice-triggered and automatically-triggered interactions with patients on behalf of the medical practice.

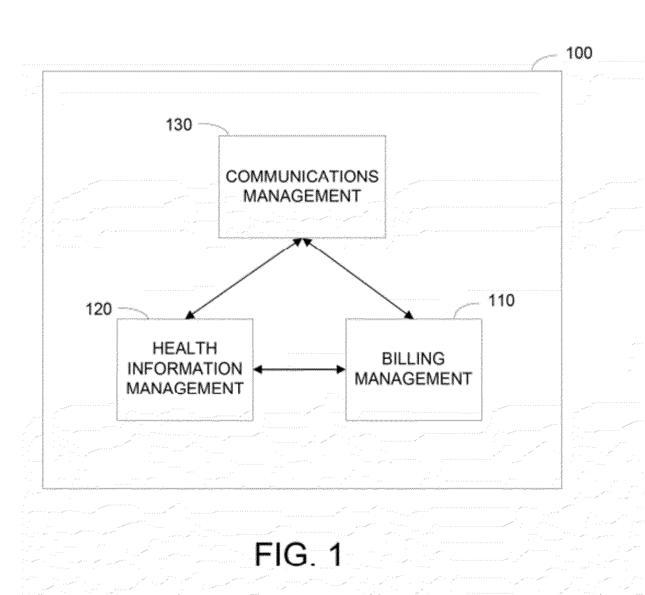

A block diagram of a practice management system in accordance with some embodiments of the invention is shown in FIG. 1. Practice management system 100 may be a networked system that includes a plurality of components configured to perform tasks related to specific functions within the practice management system to facilitate the management of medical practices.

Exemplary practice management system 100 includes billing management component 110, which is configured to facilitate the collection and tracking of claims filed by the medical practice to a plurality of payers (including patients) to ensure that the medical practice is properly compensated for medical services rendered to patients treated at the medical practice. Practice management system 100 also includes health information management component 120, which is configured to store electronic health information for patients at medical practices including, but not limited to electronic medical records, lab results, and pay for performance requirements related to patients of the medical practice. Billing management component 110 and health information management component 120, although potentially complex in their own right, are not described further in this application for the sake of brevity.

Practice management system 100 also includes communications management component 130, which interacts with health information management component 120 and billing management component 110 to automate interactions with patients on behalf of the medical practice. Although practice management system 100 is only shown as having three components, it should be appreciated that practice management system 100 may include any number of components that interact in any suitable way and embodiments of the invention are not limited in this respect. Furthermore, some or all of the components in practice management system 100 may interact by sharing data, triggering actions to be performed by other components, prevent actions from being performed by other components, storing data on behalf of other components, and/or interacting in any other suitable way.

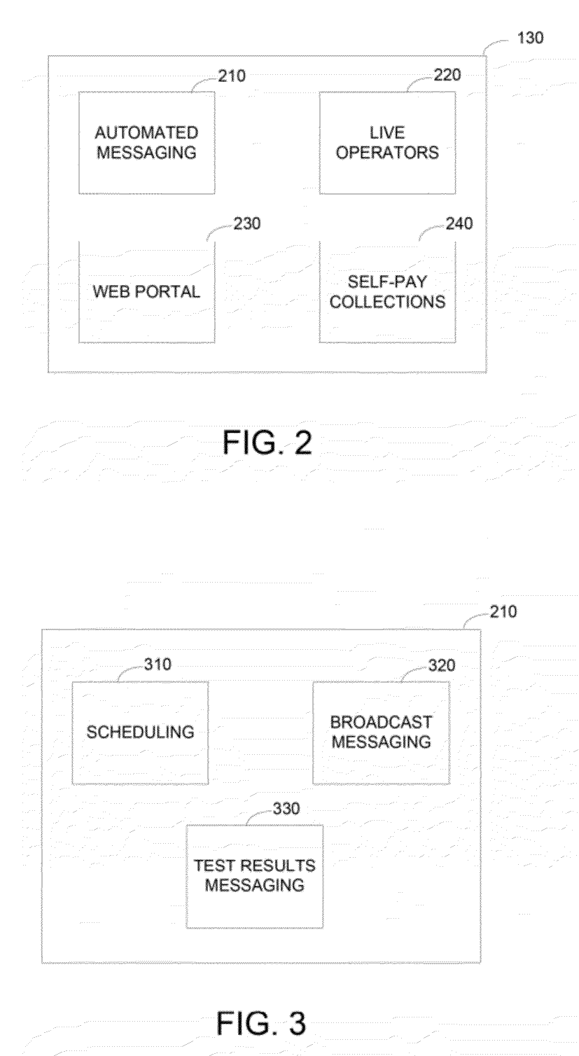

FIG. 2 illustrates a block diagram of communications management component 130 in more detail. In some embodiments, communications management component 130 includes automated messaging component 210, which is configured to use information stored in practice management system 100 to deliver and receive automated communications with patients of a medical practice using one or more communication media including, but not limited to, automated phone calls, email, text messages, and web-based posts. Such automated communications reduce the burden on staff at a medical practice who are often required to manually initiate such communications using conventional methods such as phone calls or mail.

Applicants have realized and appreciated that some interactions may be difficult to achieve using automated messaging and such interactions may be facilitated by speaking to a live person. In some instances, these interactions may be handled by staff of a medical practice. However, if the number of calls received by a medical practice is substantial, patients may be put on hold for long periods of time, thereby frustrating the patient. Additionally, some medical practices may only be staffed during certain “business hours” and interaction with the medical practice may be unavailable at other times. To facilitate patient interactions with a medical practice in these instances (and others), communications management component 130 may also include live operators component 220, which is configured to connect patients to a live operator (e.g., over the telephone, via a live chat, etc.). Live operators component 220 may interact with information in practice management system 100 to route communications to a live person who may assist a patient on behalf of a medical practice. Accordingly, live operators component 220 expands a patient's access to care and allows them to accomplish a significant amount of interaction with the medical practice at times that are most convenient to the patient.

With the rapid adoption of web-based technologies and Internet usage in general, many patients have become familiar with using the Internet to access medical information online (e.g., from medical websites such as “www.webmd.com,” “www.healthline.com,” etc.) using a computing device such as a laptop, desktop, cellphone, smartphone, PDA, or other type of computing device. Furthermore, many patients are familiar with purchasing products and/or paying bills online. However, despite the widespread deployment of web-based interactions, patients do not typically have online access to their personal health information (PHI) or other sensitive medical information related to their interactions with a medical practice. Accordingly, in some embodiments, communications management component 130 comprises web-based portal 230.

Web-based portal 230 may be configured to interact with other components of practice management system 100 to enable a patient to perform a plurality of actions associated with a medical practice including, but not limited to, registering to be a new patient at a medical practice, providing a third party with access to interact with the medical practice, secure messaging of PHI with authorized medical personnel, submitting electronic payment information for medical bills, accessing educational content, completing medical forms, and receiving directions to the medical practice. An exemplary implementation of web-based portal 230 in accordance with some embodiments of the invention is described in more detail below.

Securing timely payments for medical services from patients without having to resort to independent collections agencies is an important consideration for medical practices. Accordingly, in some embodiments, communications management component 130 includes self-pay collections component 240, which is configured to interact with other components of practice management system 100 (e.g., billing management component 110) to provide patients with access to financial information including, but not limited to enabling patients to view billing statements, keep track of their balance, and secure payments online using a credit card, bank information, and/or any other suitable type of electronic funds (e.g., Paypal®). In some implementations, self-pay collections component 240 may interact with web portal 230 to enable patients to make online secure transactions to pay outstanding medical bills.

Communications management component 130 may include additional or fewer components than those shown in FIG. 2 and embodiments of the invention are not limited in this respect.

FIG. 3 illustrates a block diagram of automated messaging component 210 configured to provide a plurality of automated messaging services to patients on behalf of a medical practice. As described above, scheduling and confirmation of appointments for patients is often a time-consuming and arduous process for a medical practice using conventional scheduling techniques. Furthermore, patients that do not show up for their scheduled appointments (i.e., no-shows) may cost the medical practice a significant amount of revenue. To facilitate the patient scheduling process, automated messaging component 210 includes scheduling service 310, which may be configured to automatically deliver pre-appointment information and instructions to patients via email, home phone, cell phone, short message service (SMS)/Text messaging, a web-based portal (e.g., web portal 230), or using any other suitable communication media. In some embodiments, patients may be able to set their preferred mode or modes of communication, and scheduling service 310 may consult the preferred mode(s) for the patient when sending automated messages.

Any suitable scheduling content may be transmitted to a patient in an automated message from scheduling service 310 including, but not limited to, appointment dates, appointment times, appointment type, required pre-appointment instructions, appointment location, directions to the medical practice, expected co-pay requirements, eligibility requirements, links to an account for web-based portal 230, and any other custom messages created by the medical practice. When appropriate, scheduling service 310 may interact with live operators component 220 to connect the patient to a live operator to facilitate the scheduling process.

Scheduling service 310 may also be configured to collect scheduling information from a patient and deliver it to the corresponding medical practice. For example, the patient may respond to an automated message sent by scheduling service 310 by confirming their appointment, requesting a rescheduling of their appointment, or providing some other response, and scheduling service 310 may provide this information to the medical practice to enable staff at the medical practice to take an appropriate action.

As described in more detail below, in some embodiments, a patient may respond to an automated message sent by scheduling service 310 by scheduling or rescheduling an appointment using a web-based portal that provides the patient with real-time scheduling capabilities. For example, the patient may be able to access scheduling information for a medical practice stored by the practice management system by using the web-based portal, and the patient may be able to cancel an existing appointment, reschedule existing appointment, and/or schedule a new appointment. In some embodiments, at least some of the scheduling information accessible to the patient is also accessible to one or more users at medical practice who schedule patients. Appointment scheduling using a web-based portal, in accordance with some embodiments of the invention, is discussed in more detail below.

As described above, scheduling service 310 may interact with one or more components within practice management system 100 to determine when to send an automated message to a patient and to determine the communication medium to be used when sending the message. For example, practice management system 100 may store scheduling data for a medical practice and scheduling service 310 may be configured to periodically query the scheduling data to determine which patients to send a message to and what type of message to send. Stored patient preferences for mode of communication may then be accessed by scheduling service 310 and the message(s) may be sent to the patient in accordance with the stored preferences.

In some embodiments, automated messaging component 210 may include broadcast messaging service 320 configured to deliver broadcast messages to patients on a variety of healthcare topics based, at least in part, on information stored in practice management system 100. Content delivered via broadcast messaging service 320 may include, for example, compliance-driven “call-to-action” information (e.g., schedule your diabetes A1C check, refill your prescription, take your medication, referrals to a specialist), weather-related closing announcements for the medical practice, notices of past due balances, no-show rescheduling messages, informational and/or marketing announcements, a link to provide the patient with access to web portal 230, and/or any other suitable message. In return, patients may respond to automated messages sent via broadcast messaging service 320 and broadcast messaging service 320 may relay the response to the appropriate medical provider or connect the patient to a live operator (e.g., via live operators component 220) for real-time assistance, if appropriate.

Communications using broadcast messaging service 320 may be transmitted using any suitable communications medium including, but not limited to email, home phone, cell phone, short message service (SMS)/Text messaging, and a web-based portal (e.g., web-portal 230). In some embodiments, patients may specify a preferred mode of communication for automated messages sent via broadcast messaging service 320, and the preferred mode of communication may be the same or different than a preferred mode of communication specified for automated messages sent using scheduling service 310.

Broadcast messaging service 320 may interact with one or more components of practice management system 100 to determine when to send automated messages to patients and the content of the message to send. For example, a physician may prescribe a medication to a patient during a visit to a medical practice and the physician may instruct the patient to take the medication daily for two weeks. The medication schedule may be stored as data in practice management system 100, and broadcast messaging service 320 may query the stored data associated with the medication schedule to determine when an automated message should be sent to the patient to remind the patient to take the medication. When it is determined that a reminder should be sent, broadcast messaging service 320 may consult a message datastore to select appropriate content for the automated message or broadcast messaging service 320 may provide a customized message created by a physician, pharmacist, or other qualified individual that reminds the patient to take the medication.

In another example, broadcast messaging service 320 may query scheduling data stored in practice management system 100 to determine all patients at a medical practice who have not scheduled an annual checkup within the past year. Upon receiving such data, broadcast messaging service 320 may send an automated message to each of the identified patients reminding them that they should schedule an appointment for an annual physical. For example, the practice management system may include a pay-for-performance component configured to manage information related to at least one pay-for-performance program with which a medical practice is associated. Broadcast messaging service 320 may be configured to interact with the pay-for-performance component to generate one or more automated messages based, at least in part, on pay-for-performance program information managed by the pay-for-performance component.

Broadcast messaging service 320 may also interact with billing management component 110 to determine which patients have past due balances and should be reminded to make a payment. In such instances, broadcast messaging service 320 may transmit remittance instructions to the patient with one or more options for remitting a payment including making an electronic payment via web portal 230 or contacting a live operator via live operators component 220.

Broadcast messaging service 320 may interact with other components of practice management system 100, including health information management component 120, to generate and send automated messages to a patient or a group of patients based, at least in part, on information stored in practice management system 100 (e.g., information stored about one or more pay-for-performance programs). For example, in some embodiments, broadcast messaging service 320 may periodically query health information management component 120 to determine patients at a medical practice that have recently been diagnosed as having high-blood pressure. In response to determining a subset of patients that fit this criteria, broadcast messaging service 320 may send targeted educational information to the identified patients to enable the patients to learn, for example, lifestyle changes that they can make to reduce their blood pressure. In some implementations, rather than sending actual educational information to the patient, broadcast messaging service 320 may send a link to a website or and/or a reference to one or more printed or electronic materials comprising educational information. By making educational messages targeted to patients based on their particular health condition, patients without the particular health condition may not receive information that is not relevant to them. Furthermore, patients that meet the criteria outlined in the query may find the educational information particularly useful given their health condition.

Queries for generating appointment scheduling reminders, billing reminders, educational information, etc. to be sent to patients by broadcast messaging service 320 may be created by one or more authorized users of practice management system 100 at the medical practice including, but not limited to, a physician, a nurse, and a billing specialist. The queries may be executed by one or more processors in practice management system 100 configured to facilitate interactions between communications management component 130 and other components of practice management system 100.

In some embodiments, automated messaging component 210 may also include test results messaging service 330, which may be configured to automate the delivery of test and/or lab results to patients using data received, for example, from laboratories and that is stored in practice management system 100. Content delivered to patients from test results messaging service 330 may include images with or without associated text entered by medical practice personnel, and specific values stored in practice management system 100 via third party interfaces or scanned documents. Upon receiving test results messages from test results messaging service 330, patients may respond by delivering messages to the medical practice or may connect to a live operator for real-time assistance, if appropriate.

In some embodiments, one or more components of communications management component 130 may interact with components from practice management system 100 to prevent automated messages from being sent to a patient based on data stored in practice management system 100. For example, in some embodiments automated messages may be generated by the practice management system during a time of day when most people would not want to receive such messages (e.g., the middle of the night). Such messages may be held in a queue until a designated time after which the automated message is transmitted to the patient. However, the patient may have taken an action that rendered the message unnecessary while the message was in the queue waiting to be delivered. For example, each night at 2:00 AM, practice management system 100 may be configured to query billing management component 110 to identify all patients of a medical practice with past due balances. After identifying such patients, broadcast messaging service 320 may generate automated reminder messages to be sent to the patients with past due balances. However, since the messages are created at a time that many people would not appreciate receiving messages, the generated messages may be held in a queue in practice management system 100 until some later time (e.g., 10:00 AM the next day), after which the automated messages are sent to the patients. Prior to sending the messages, however, broadcast messaging service 320 may query billing management component 110 and/or associated billing data stored in practice management system 100 to determine if any of the patients associated with the queued messages has paid their balance while the messages were held in the queue. If any such patients are identified, the corresponding messages are deleted from the queue and are not sent to the patients who have paid their balance. By performing a real-time check of the data in practice management system 100 prior to sending queued automated messages, patients are not sent messages when there is no action for them to take.

One or more components of practice management system 100 may interact with communications management component 130 to trigger the generation of an automated message or prevent the transmission of an automated message based on real-time monitoring of updates to data in practice management system 100. For example, in some implementations, entry of particular types of health information into health information management component 120 may automatically trigger communications management component 130 to generate an automated message comprising educational information related to the entered health information, if such educational information is stored in practice management system 100. In some embodiments, patients may set preferences on the amount of educational information, or other types of automated messages they would like to receive, and communications management component 130 may consult these preferences prior to generating and/or sending such automated messages to the patient.

Another example of interaction between components in practice management system 100 relates to when it is determined by billing management component 110 that remittance has been received for a claim, but that there is still an outstanding balance on the claim that the patient is responsible for paying. In such an instance, billing management component 110 may send a request to communications management component 130 to generate an automated message to the corresponding patient that although payment has been received, the patient is responsible for paying the remaining balance on the claim. As discussed above, prior to sending the automated message to the patient, practice management system 100 may determine whether the claim has already been paid by the patient, thereby obviating the need to send the automated message. By checking the real-time status of information in practice management system 100 prior to sending automated messages, patients are provided with the up-to-date information, and the collection of payments by the medical practice from the patient may be improved.

Interactions between components in practice management system 100 may be triggered in any suitable way and embodiments of the invention are not limited in this respect. In some embodiments, practice management system 100 may store and execute a plurality of rules, configured to take specific actions upon the occurrence of one or more detected actions. For example, in response to detecting that a patient has requested a cancellation of an appointment via web portal 230, as discussed below, a rule stored in practice management system 100 may cause the generation of an automated message to a patient on a waiting list in order to quickly fill the appointment slot vacated by the cancelling patient. Other examples of rules are also possible, and the above example is provided merely for illustrative purposes.

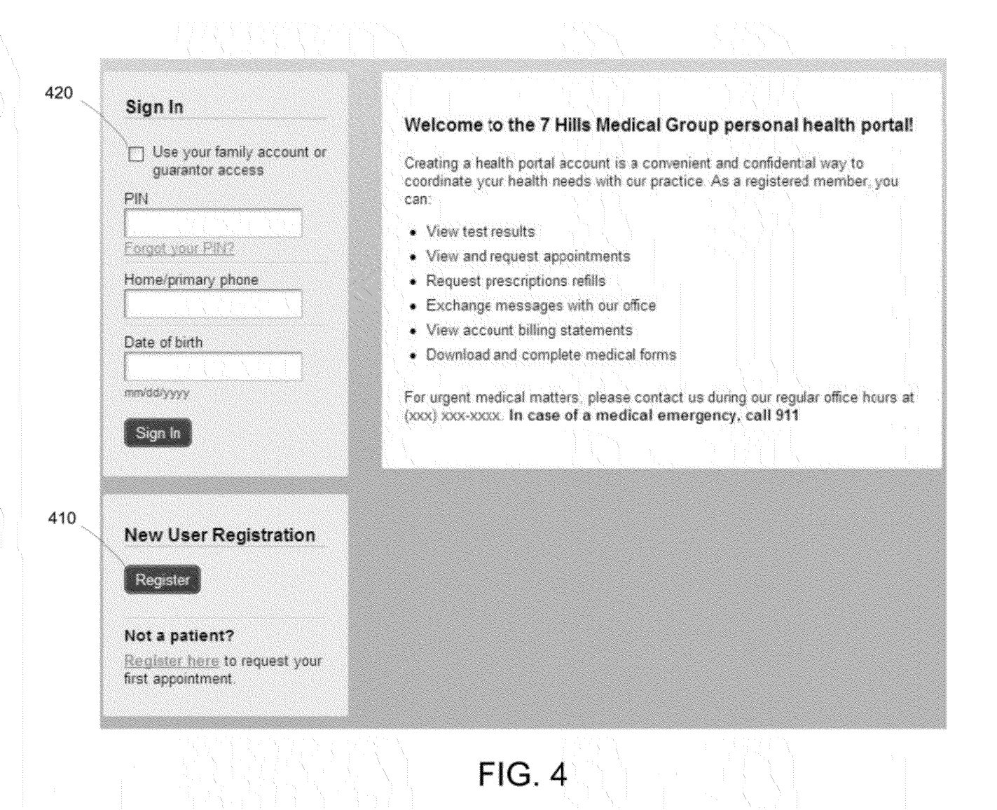

Some embodiments are directed to a web portal 230 for enabling patients to perform a plurality of actions for communicating with a medical practice and/or for accessing PHI stored in a practice management system. An exemplary sign-in page for web portal 230 in accordance with some embodiments of the invention is illustrated in FIG. 4. As shown in FIG. 4, a user may provide identifying information including, but not limited to, a personal identification number (PIN), a phone number, and/or a date of birth to access web portal 230. If the user is not registered for web portal 230, the user may interact with register selector 410 to provide registration information. As discussed in more detail below, in some embodiments, a patient may grant a third party, such as a family member or guarantor, access to web portal 230 to enable the third party to interact with web portal 230 on behalf of the patient. To enable third party access, a sign-in page for web portal 230 may include third party access selector 420. When third-party access selector 420 is selected, the third party may use identifying information other than the patient's identifying information to sign in to web portal 230.

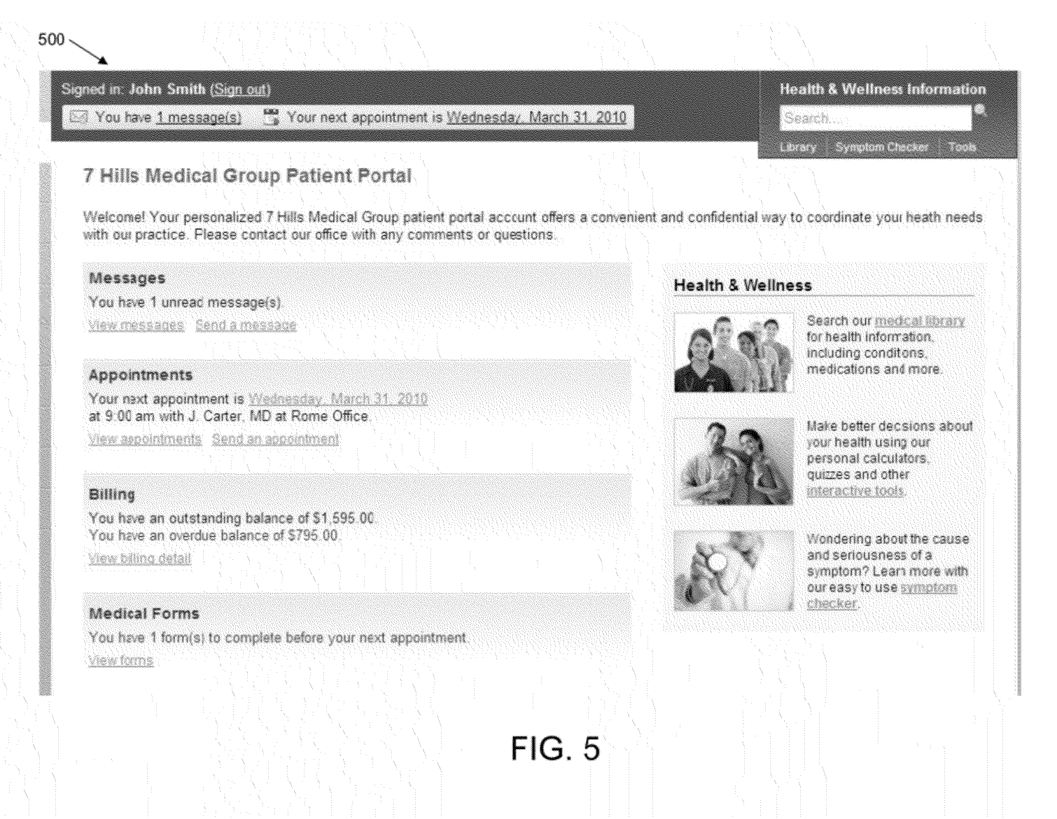

As illustrated in FIG. 5, after a user (e.g., a patient or a third party acting on behalf of a patient) has signed in to web portal 230, home page 500 for web portal 230 with patient-specific information may be displayed. Home page 500 may include summary information for each of multiple types of interactions that the user may make with web portal 230. For example, home page 500 may display summary information for electronic messages (e.g., an email inbox), upcoming and/or past appointments, billing information, medical forms, educational information, and/or any other type of suitable information. The user may interact with one or more selectors (e.g., links) displayed on home page 500 to navigate to other portions of web portal 230 in order to perform one or more interactions.

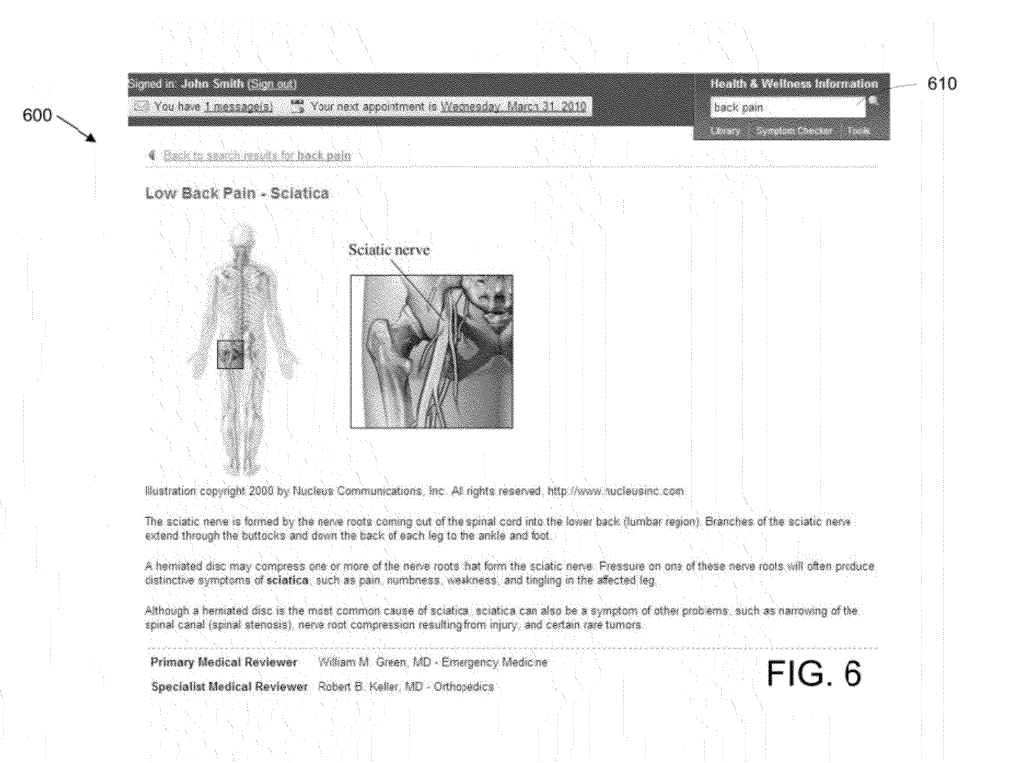

For example, a user may select a link displayed in an educational information section of home page 500, which may result in an educational information page 600 to be displayed, as shown in FIG. 6. A user may interact with educational information page 600 by, for example, searching for educational information using search engine 610. Educational information page 600 may display information relating to one or more symptoms or keywords entered by a user in search engine 610. For example, as shown in FIG. 6, a user may enter the symptom “back pain” in search engine 610, and in response, educational information page 600 may display images and/or text related to possible causes of back pain (e.g., dysfunction of the sciatic nerve). The educational information displayed on educational information page 600 may be stored in practice management system 100 or the educational information may be found on other web-based sources such as medical information web pages, and embodiments of the invention are not limited in this respect.

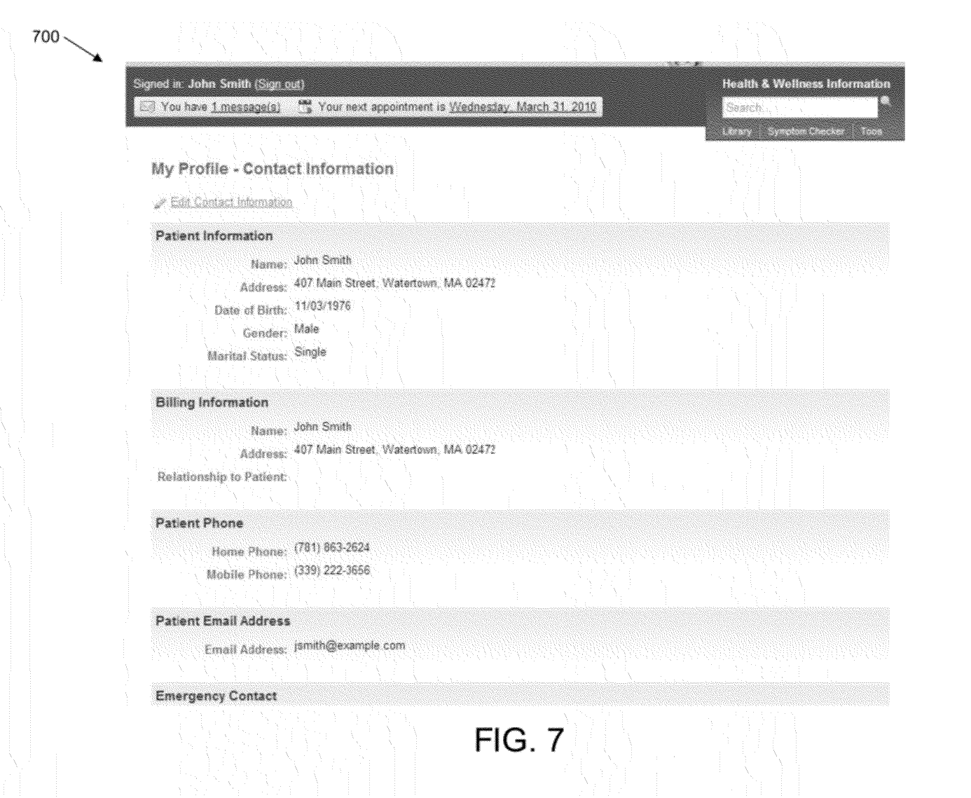

A user may also interact with web portal 230 to select profile page 700 as shown in FIG. 7. On profile page 700, a user may modify one or more patient profile characteristics stored by practice management system 100 for the patient. As shown in FIG. 7, a user may view and/or change current contact information for the patient including information the patient's mailing address, billing information, phone information, email information, emergency contact information, or any other information such as messaging mode preference information, as described above.

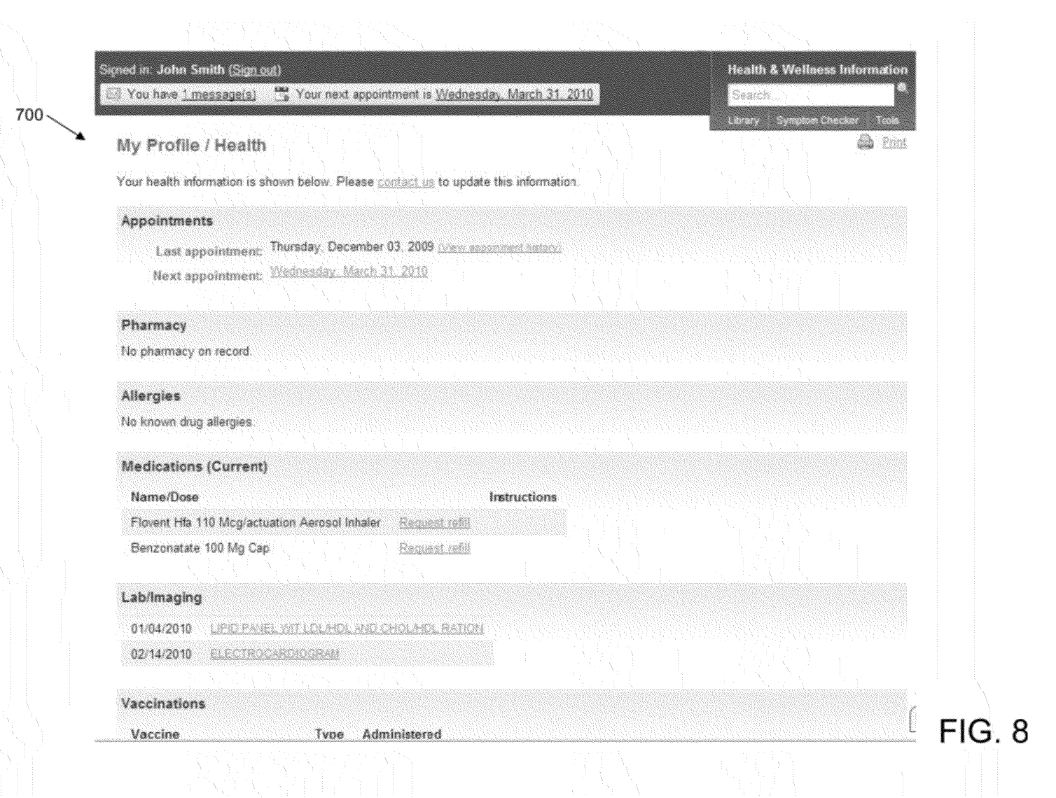

As shown in FIG. 8, profile page 700 may also include a portion to view and/or change stored health information for the patient (e.g., the patient's medical record) including, but not limited to, appointment information, pharmacy information, allergy information, current medication information, test results information, vaccination information, and any other health information. In many conventional medical systems, when a patient arrives at a medical practice for an appointment, the patient must fill out a form detailing their current health information. Alternatively, a nurse, physician, or other medical professional may ask the patient for this information prior to examining the patient. However, because patients can update current health information using profile page 700 in accordance with some embodiments of the invention, the process of collecting health information at the medical practice may be expedited. That is, prior to a patient's appointment, practice management system 100 may send an automated message to the patient to remind the patient to update their current health information. Then, when the patient arrives at the medical practice for their appointment, the medical practice may access the current health information for the patient and ask the patient if the information is current or if there are any changes. By enabling the patient to enter the information prior to the appointment, valuable time at the medical practice is saved resulting a more efficient workflow when the patient arrives at the medical practice.

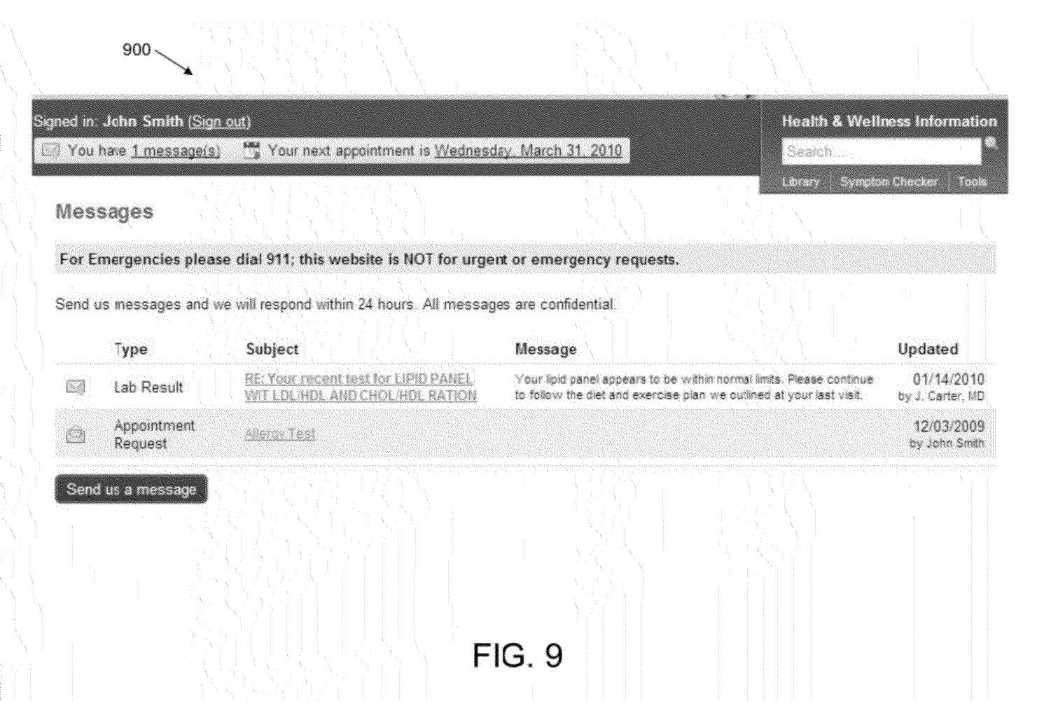

A user may also interact with web portal 230 to select messages page 900 as shown in FIG. 9. As described earlier, communications management component 130 of practice management system 100 may be configured to send automated messages to a patient based on information stored by practice management system 100. In some embodiments, automated messages sent by communications management component 130 may be made provided to a patient via web portal 230 as shown in FIG. 9. Additionally, a user may interact with portions of messages page 900 to send messages to a medical practice and/or a live operator associated with practice management system 100. Messages page 900 may display any suitable type of messages including messages sent from a medical practice, a laboratory, an administrator of practice management system 100, or any other authorized user of practice management system 100.

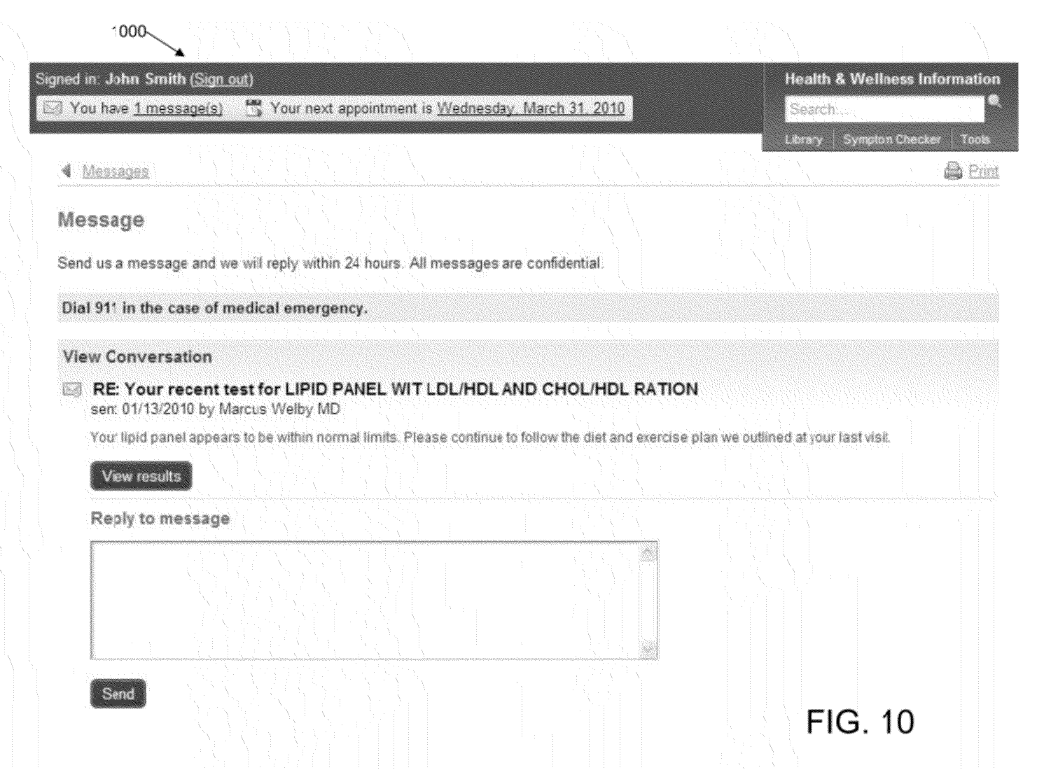

In some embodiments, a user may interact with web portal 230 to review lab results via lab results page 1000, as shown in FIG. 10. Lab results page 1000 may be configured in any suitable way and embodiments of the invention are not limited in this respect. For example, lab results page 1000 may include at least one field for entering text and/or uploading an attachment such as an image or file to be transmitted to a medical practice and/or a live operator of practice management system 100. Lab results page 1000 may also include other information including, but not limited to, instructions from a physician related to a displayed lab result, as shown in FIG. 10.

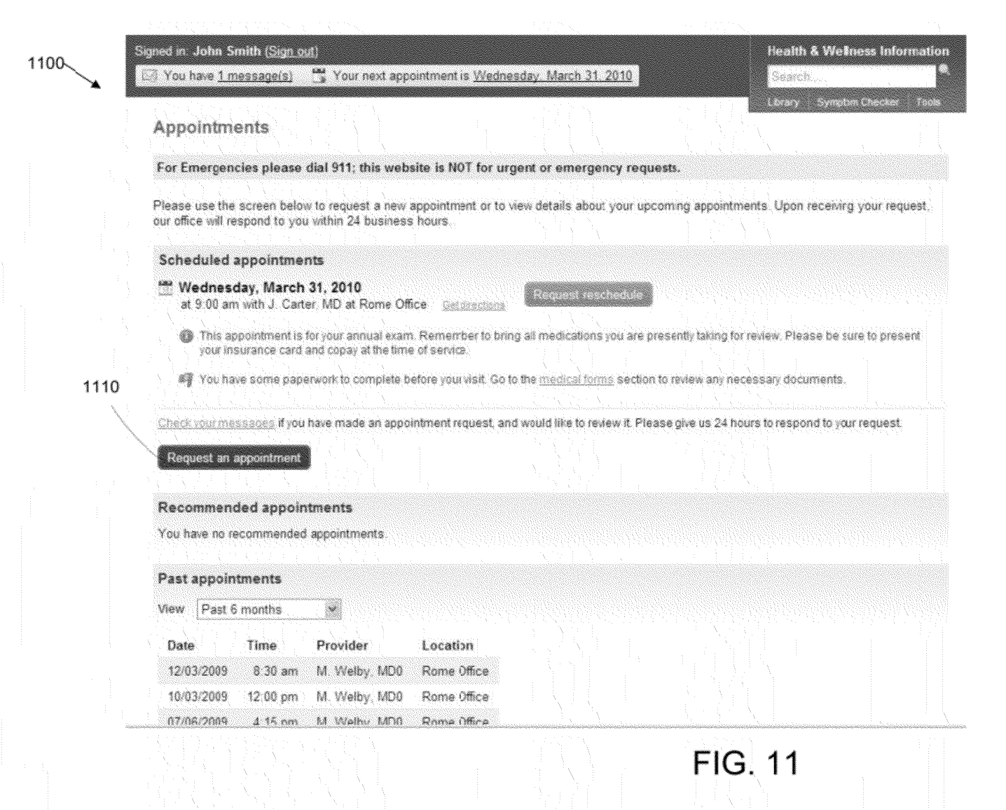

A user may interact with web portal 230 to select appointments page 1100, as shown in FIG. 11. The user may interact with appointments page 1100 to view and/or reschedule scheduled appointments, request an appointment, and/or view information about past appointments. Information related to specific appointments (e.g., scheduled appointments) including, but not limited to, directions instructions, appointment type, and appointment instructions (e.g., what to bring to the appointment) may also be displayed on appointments page 1100.

In some embodiments, appointments page 1100 may also include recommended appointment information that is generated by communications management component 130 as described above. For example, communications management component 130 may search for all patients at a medical practice that have not had an annual exam within the past year, and a corresponding recommended appointment to schedule an annual exam may be displayed on appointments page 1100 for each of the patients that are identified in the search. By interacting with data stored in practice management system 100 and by interfacing web portal 230 with communications management component 130, patients are provided with up-to-date information regarding multiple aspects of their interaction with a medical practice.

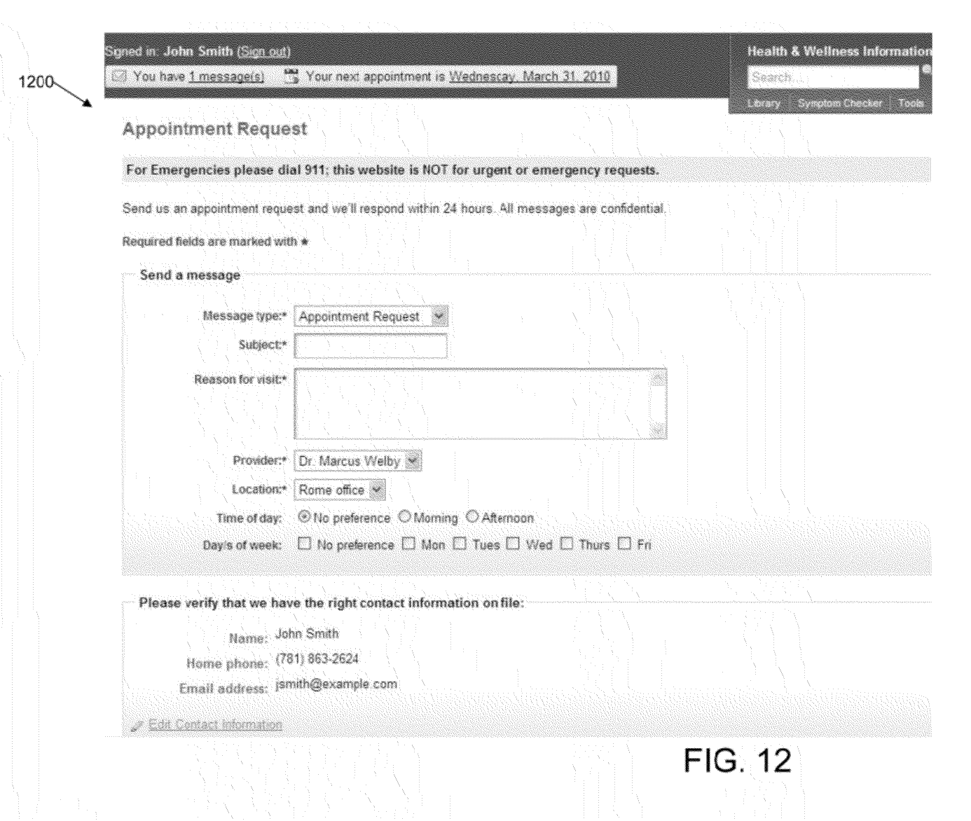

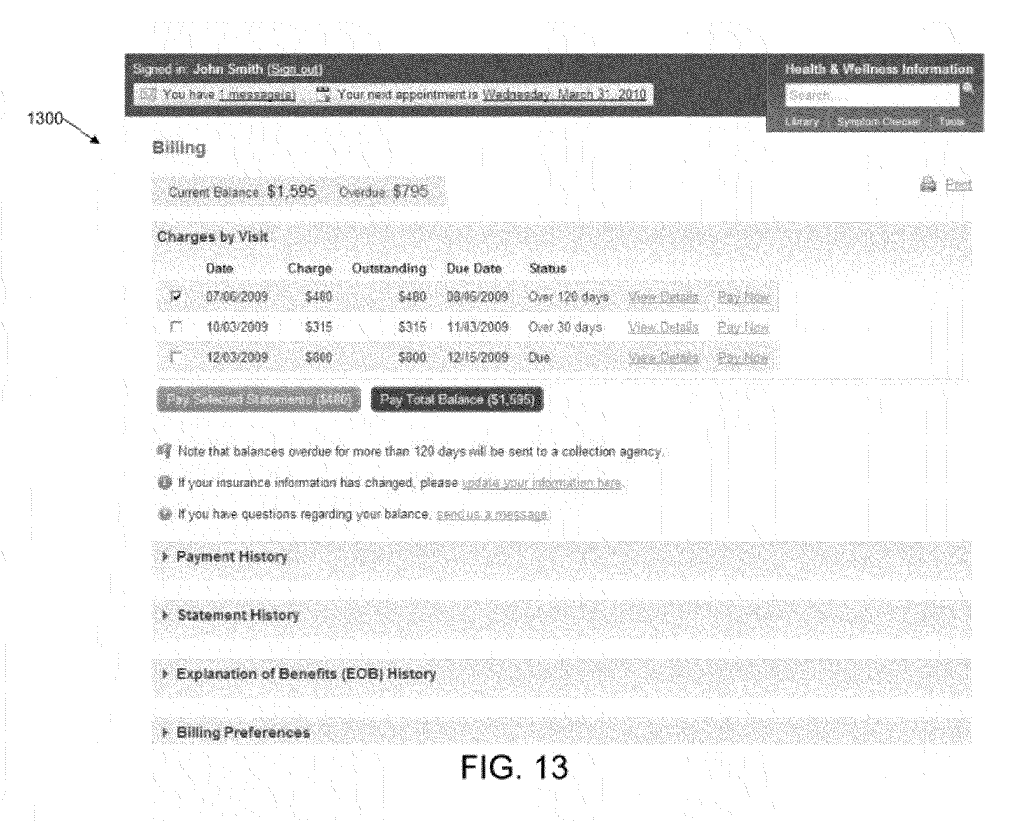

If a user wants to schedule a new appointment, the user may interact with new appointment selector 1110, which may result in the display of appointment request page 1200, as shown in FIG. 12. A user may interact with appointment request page 1200 to provide a medical practice with necessary information to schedule a new appointment. For example, the user may provide a reason for the appointment and a medical services provider and location of the medical practice. The user may also specify a preference for a time of day and/or preferred day(s) of the week on which they would like the appointment to be scheduled. As described in more detail below, a message may be sent to the medical practice, and staff at the medical practice may use this information to schedule a time for the appointment. In some embodiments, available scheduling slots for an appointment may be suggested to the patient at the time of requesting a new appointment, wherein the scheduling slots are based, at least in part, on a scheduling calendar provided by the medical practice. The scheduling calendar may be stored by the practice management system 100 or may be made accessible to web portal 230 in any other suitable way.

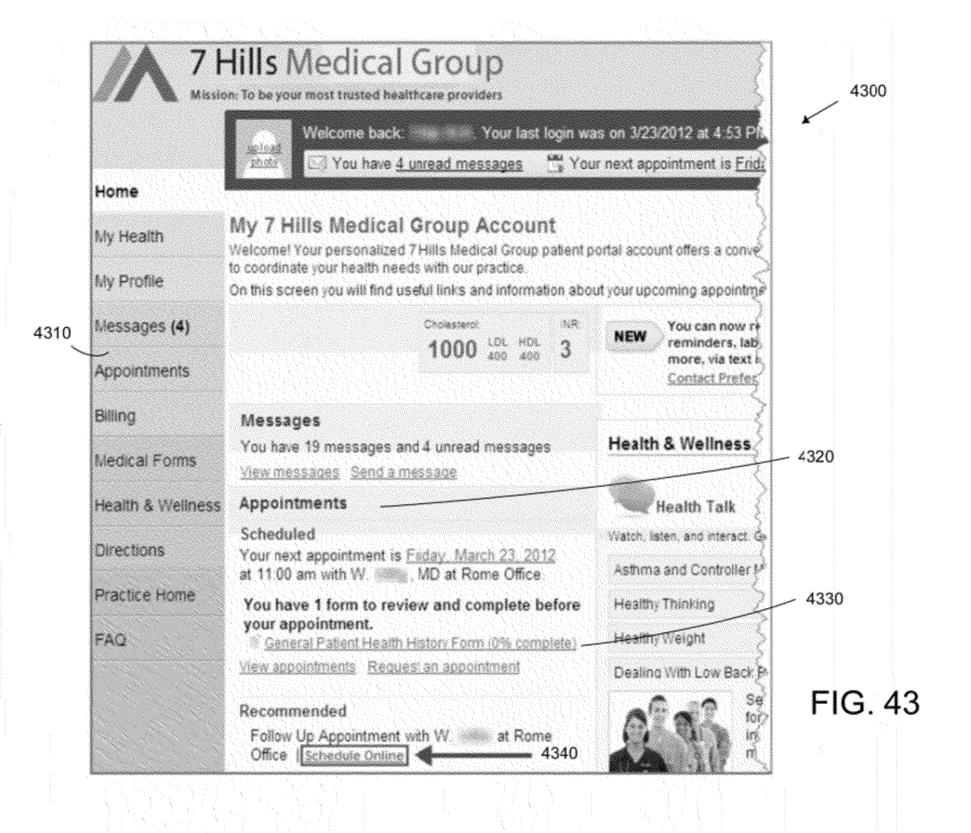

As discussed above, in some embodiments, a user may interact with web portal 230 to schedule, reschedule, or cancel an appointment interactively, without having to separately contact the medical practice by sending the medical practice a message to request scheduling, as just described. FIG. 43 illustrates an exemplary dashboard page 4300 of web-based patient portal 230. Dashboard page 4300 may include one or more user interface elements with which the user can interact to schedule, reschedule, or cancel an appointment. Dashboard page 4300 includes appointments tab 4310 that, when selected by the user, enables the user to review one or more appointments currently scheduled for the patient at the medical practice.

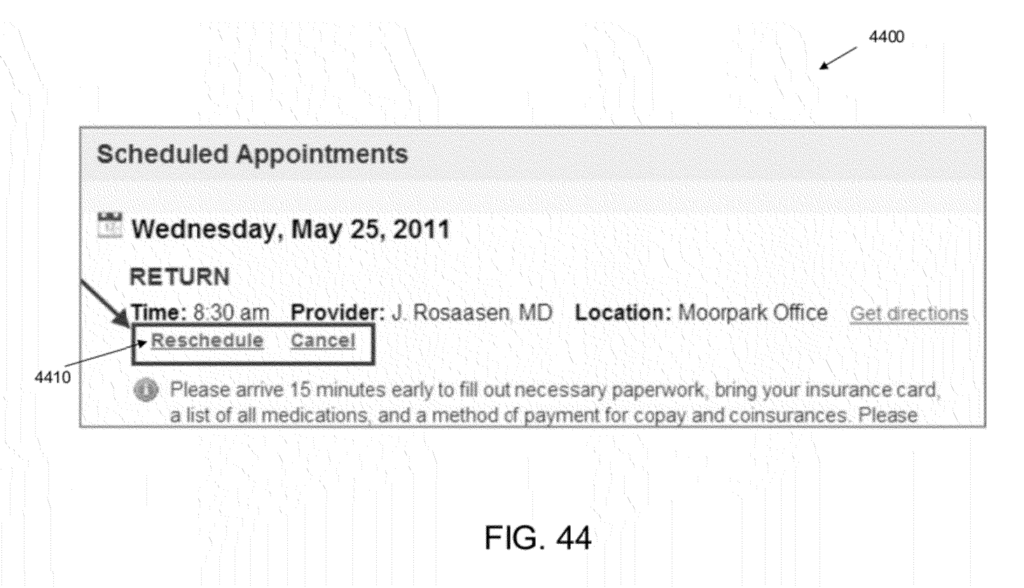

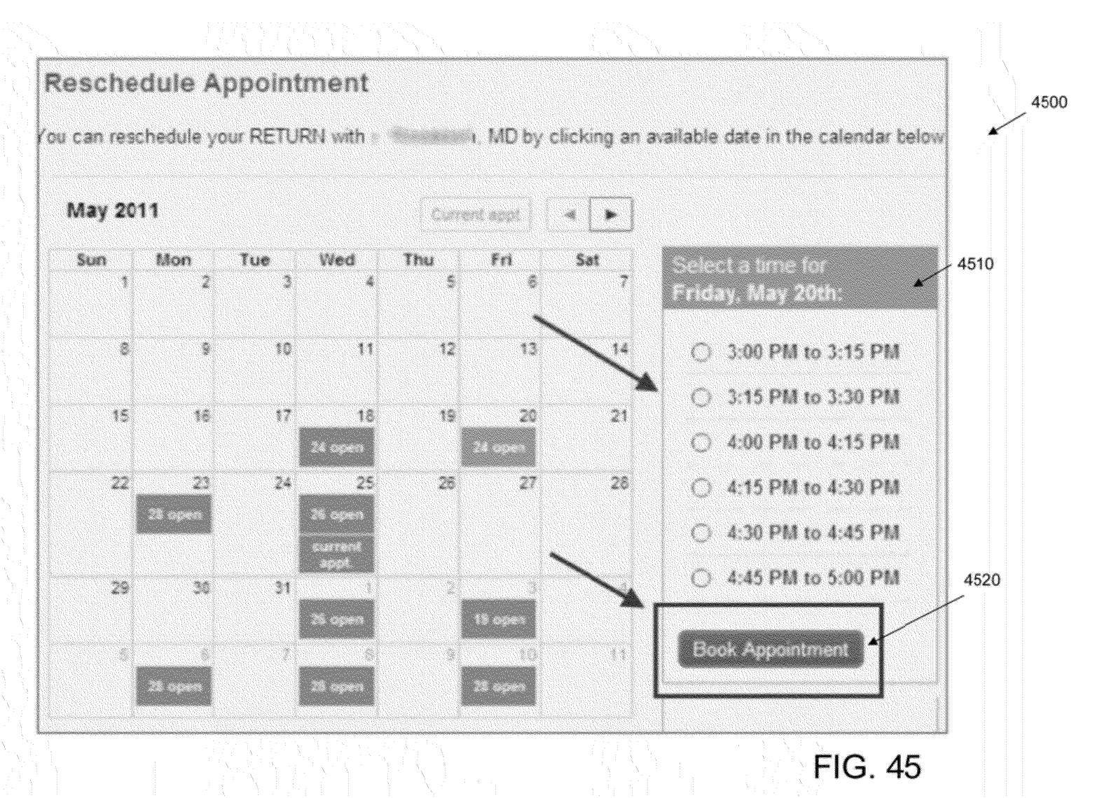

In response to selecting appointments tab 4310, the web-based portal 230 may display a scheduled appointments page 4400 as shown in FIG. 44. Scheduled appointments page 4400 may include one or more scheduled appointments for the user and the user may interact with scheduled appointments page 4400 to select at least one of the appointments to reschedule or cancel. Scheduled appointments page 4400 may also include other information and/or links to information regarding the scheduled appointment. For example, scheduled appointments page 4400 may include information about directions to the medical practice for the scheduled appointment and other information regarding paperwork for the scheduled appointment. In response to indicating that the user wants to reschedule or cancel an appointment, the web-based portal 230 may display an interactive scheduling page 4500, an example of which is illustrated in FIG. 45 and described is in more detail below.

Dashboard page 4300 may also include an appointment summary section 4320, which summarizes the user's appointment information. For example, in the example shown in FIG. 43, the user has one scheduled appointment and one recommended follow-up appointment. Additionally, dashboard page 4300 indicates that the user has a form to review and complete before the scheduled appointment. The user may interact with form selector 4330 to complete the form prior to the scheduled appointment.

As discussed above, a patient may be sent one or more automated messages to inform them that they should consider scheduling a new appointment. The new appointment may be recommended as a follow-up appointment as shown in dashboard page 4300, or the new appointment may be recommended for any other suitable reason such as, the user meeting some criteria stored by the practice management system for recommending a new appointment. For example, all female patients of a medical practice that have not been scheduled for a yearly mammogram may be sent an automated message recommending that an appointment be scheduled.

The user may interact with scheduling selector 4340 to schedule an appointment online without having to separately contact the medical practice. In response to selecting scheduling selector 4340 or in response to selecting some other selector such as reschedule selector 4410 shown on scheduled appointments page 4400 of FIG. 44, the web-based portal 230 may display interactive scheduling page 4500 shown in FIG. 45 to enable the user to schedule or reschedule an appointment at the medical practice.

As illustrated in FIG. 45, the options for scheduling or rescheduling an appointment may be restricted based, at least in part, on information stored by the practice management system. In some embodiments, a medical practice may configure a number and/or a type of appointments available on particular days. For example, a medical practice may only see dermatology patients on Wednesday afternoons and if the user is attempting to reschedule a dermatology appointment, the practice management system may indicate that only appointments on Wednesday afternoons are available for rescheduling. In some embodiments, interactive scheduling page 4500 may be updated occasionally, such that the appointment availability shown in interactive scheduling page 4500 illustrates the real-time availability for scheduling appointments at a medical practice.

After determining when the user would like to schedule or reschedule an appointment, the user may interact with interactive scheduling page 4500 to select a particular time for scheduling or rescheduling the appointment from the available choices. As discussed above, not all available days and/or timeslots may be made available to the patient for scheduling an appointment via web-based portal 230. For example, in some embodiments, a medical practice may configure the scheduling component of the practice management system to permit patients to schedule appointments only during certain days/times, while reserving other days and/or timeslots for scheduling using other means (e.g., scheduling by staff at the medical practice) and/or for other types of appointments. The days/times that are available for scheduling appointments may be indicated on interactive scheduling page 4500 in any suitable way. For example, days/times that are available for scheduling appointments may be indicated using text, color, or any combination of text and color.

In response to receiving a selection of a particular day for scheduling an appointment, interactive scheduling page 4500 may show available appointment times on the selected day as shown in timeslot portion 4510 of interactive scheduling page 4500. In some embodiments, the available timeslots illustrated in timeslot portion 4510 may be determined based, at least in part, on scheduling information related to the type of appointment, and configuration information stored by the practice management system for the medical practice.

The user may select one of the available timeslots by interacting with timeslot portion 4510. In response to the user selecting one of the available timeslots and selecting book appointment selector 4520, the scheduling information stored by the practice management system may be updated. Accordingly, in some embodiments, a patient may interactively schedule appointments or reschedule appointments based on the current schedule of a medical practice as stored by a scheduling component of a practice management system, without the need to issue a request to the medical practice with recommended times for scheduling/rescheduling the appointment, thereby increasing the efficiency of the scheduling process.

In some embodiments, when a patient reschedules an appointment, a report may be sent from a communications component of the practice management system to the medical practice indicating that the patient has rescheduled the appointment using web-based portal 230.

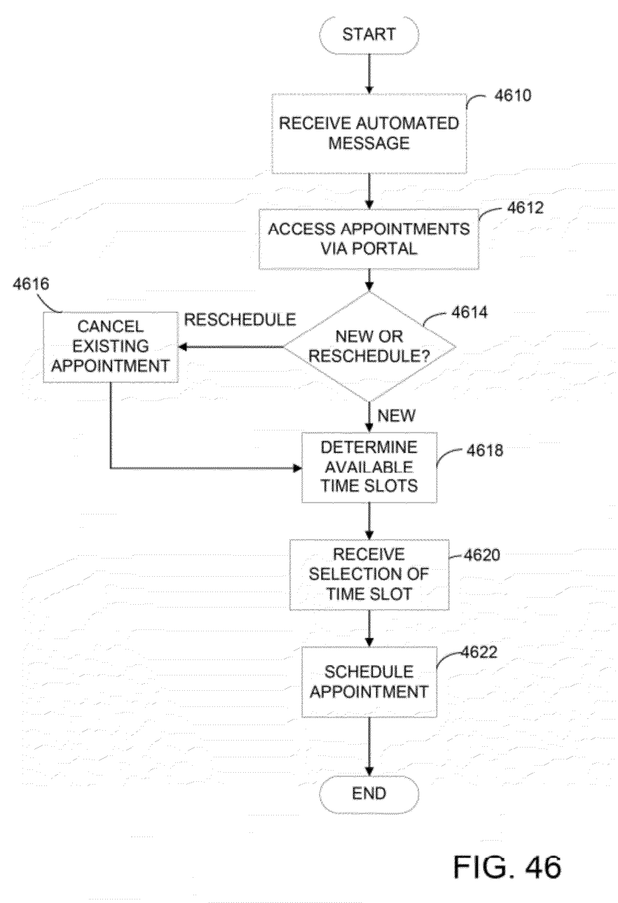

An exemplary process for scheduling an appointment in accordance with some embodiments of the invention is illustrated in FIG. 46. In act 4610, a patient may receive an automated message recommending that they should schedule an appointment. It should be appreciated, however, that an appointment may be scheduled whether or not an automated message is received by a patient, and embodiments of the invention are not limited in this respect. For example, a patient may have scheduled an appointment two months earlier and has now developed a conflict such that the patient cannot keep the currently scheduled appointment. To reschedule the appointment at a time that is more convenient, the patient may access and modify the scheduled appointment using, for example, web-based portal 230. Accordingly, it should be appreciated that the practice management system may receive a request from the patient to schedule an appointment in any suitable way.

To initiate the process of scheduling or rescheduling an appointment, the process proceeds to the act 4612, where the patient interacts with web-based portal 230 to access a scheduling component of the practice management system, as described in more detail above. The process then proceeds to act 4614, where it is determined whether the patient desires to schedule a new appointment or wants to reschedule an existing appointment. This determination may be made in any suitable way and embodiments of the invention are not limited in this respect. For example, it may be determined that the patient desires to reschedule an appointment if the user interacted with reschedule selector 4410 shown on scheduled appointments page 4400 and it may be determined that the patient desires to schedule a new appointment if the user interacted with scheduling selector 4340 to schedule a recommended follow-up appointment. Other information may also be determined from a user's request to schedule an appointment including, but not limited to, at least one attribute that facilitates searching a current schedule of the medical practice. For example, the at least one attribute may include, but is not limited to, an appointment type, a department identifier, a provider identifier, and any combination thereof.

If it is determined in act 4614 that the appointment is for a rescheduled appointment, the process proceeds to act 4616, where the existing appointment is canceled. In some embodiments, cancelling an existing appointment may be accomplished by making the timeslot available for other patients or the medical practice to schedule new patients in the timeslot. For example, scheduling information for the medical practice stored by the practice management system may be updated to reflect an available timeslot such that other patients may interactively schedule an appointment during the timeslot provided the timeslot is configured as such. In some embodiments, the patient may be prompted to provide a reason for rescheduling the appointment and information related to the reason may be stored by the practice management system.

It should be appreciated that cancelling an existing appointment in response to determining that the patient desires to reschedule an appointment may be performed at any time during the process of FIG. 46 and embodiments of the invention are not limited in this respect. For example, in some embodiments, the existing appointment may not be cancelled if and until a new replacement appointment is scheduled in act 4622. Delaying cancelling the existing appointment until after a new replacement appointment is scheduled may allow the user to exit the process and retain the existing appointment should the user change their mind prior to completing the rescheduling process.

In some embodiments, the practice management system may store information related to patients who are on a waiting list for available appointments, and in response to a timeslot becoming available that matches with a patient's appointment type, the corresponding patient on the waiting list may be sent an automated message indicating that the appointment timeslot has become available. In response, the patient receiving the message may interact with web portal 230 or using another scheduling method to schedule an appointment during the available timeslot released as a consequence of the rescheduling. By informing patients on a waiting list of appointments as they become available, the process of filling a schedule for a medical practice may become more efficient without further burdening the medical practice.

If it is determined in act 4614 that the patient desires to schedule a new appointment or upon canceling an existing appointment in act 4616, the process proceeds to act 4618, where the available timeslots for scheduling the appointment are determined. In some embodiments, the available timeslots for an appointment may be determined based, at least in part, on schedule configuration information stored by the practice management system. As discussed in more detail below, in some embodiments, a scheduling component of the practice management system may enable an administrator at a medical practice to configure which timeslots are available for particular types of appointments and this information may be stored by the practice management system as schedule configuration information. Schedule configuration information may also include other information specified by the medical practice to indicate the availability of timeslots for scheduling appointments using web portal 230, and embodiments of the invention are not limited by how a medical practice chooses to configure the stored schedule configuration information pertaining to the particular medical practice.

In response to determining the available timeslots for scheduling an appointment in act 4618, the available timeslots may be presented to the patient to enable the patient to select one of the available timeslots. The available timeslots may be presented to the patient in any suitable way including, but not limited to, presenting a calendar indicating the available timeslots, an example of which is shown in FIG. 45. The process then proceeds to act 4620, where a selection of one of the available timeslots is received. For example, a patient may interact with an interactive scheduling page to select one of the available timeslots. The process then proceeds to act 4622, where the appointment corresponding to the selected timeslot is scheduled. The appointment may be scheduled by, for example, updating a scheduling component of the practice management system that stores information related to the current schedule for the medical practice. Alternatively, the appointment may be scheduled in any other suitable way.

In some embodiments, the patient may be asked for confirmation prior to the practice management system allowing a new appointment to be scheduled using web portal 230. For example, after a patient has selected an available timeslot for the appointment, the patient may be asked (e.g., via a dialog box or other user interface element) to confirm the selection of the timeslot for scheduling the appointment. In response to receiving confirmation from the patient, the appointment may be scheduled, as described above.

Portions of web portal 230 may be used to facilitate the collection of payment for outstanding bills to a medical practice. As shown in FIG. 13, a user may interact with web portal 230 to select billing page 1300. Billing page 1300 may be configured to provide the user with an overview of outstanding bills to a medical practice, and may enable the user to make payments to outstanding bills using a credit card, a debit card, or some other type of electronic funds. Billing page 1300 may also include information regarding charges by visit to a medical practice so the user may be able to better understand outstanding bills posted on billing page 1300. Information displayed on billing page 1300 may be retrieved from billing management component 110 or any other portion of practice management system 100 so the user has an up-to-date view of all outstanding charges and can provide appropriate payment.

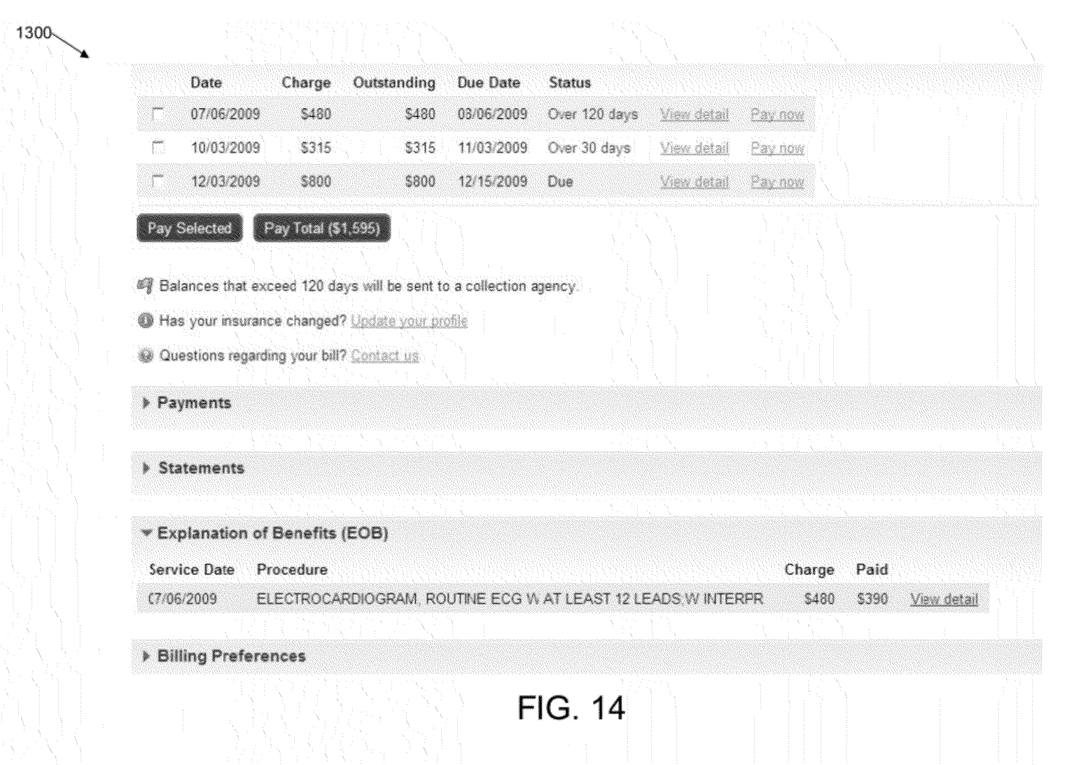

In some embodiments, billing page 1300 may also include information related to a patient's payment history, statement history, details of remittance of advice that may have been received via an explanation of benefits (EOB) or explanation of remittance advice (ERA), billing preferences, or any other suitable type of information related to medical billing. For example, as shown in FIG. 14, billing page 1300 may include detailed information regarding one or more EOB statements related to a patient's visit to a medical practice and the amount of payment made by a third party payer (e.g., the patient's medical insurance company). By viewing EOB detail, the user may better understand the outstanding charges and remit payment to the medical practice without requiring the assistance of medical practice personnel. EOB information may be retrieved from practice management system 100 such that the display on billing page 1300 is up-to-date based on recent activity to the patient's billing account.

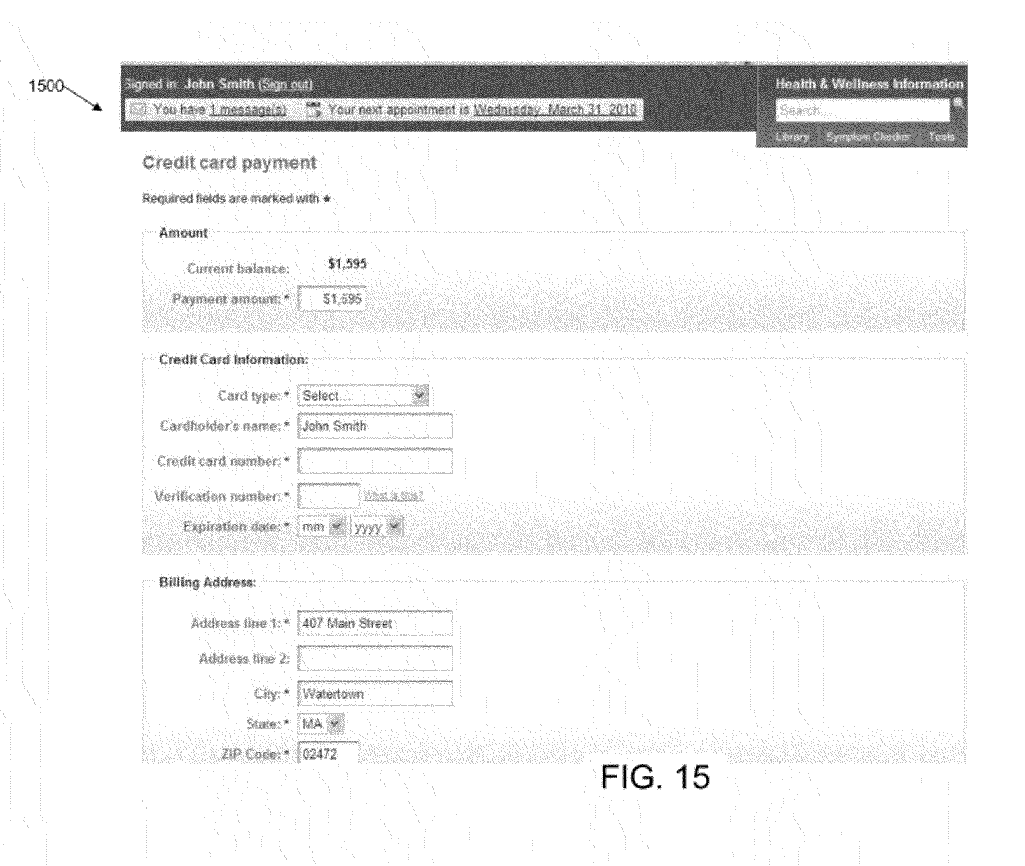

In some embodiments, web portal 230 may be configured to enable a user to remit payment to a medical practice for outstanding bills via a credit card, debit card, and/or any other suitable form of electronic payment as shown in FIG. 15. Information displayed on credit card payment page 1500, such as a patient's current outstanding balance, may be retrieved from billing management component 110 in practice management system 100. A user may interact with credit card payment page 1500 to enter credit card information for paying an outstanding balance or some portion thereof.

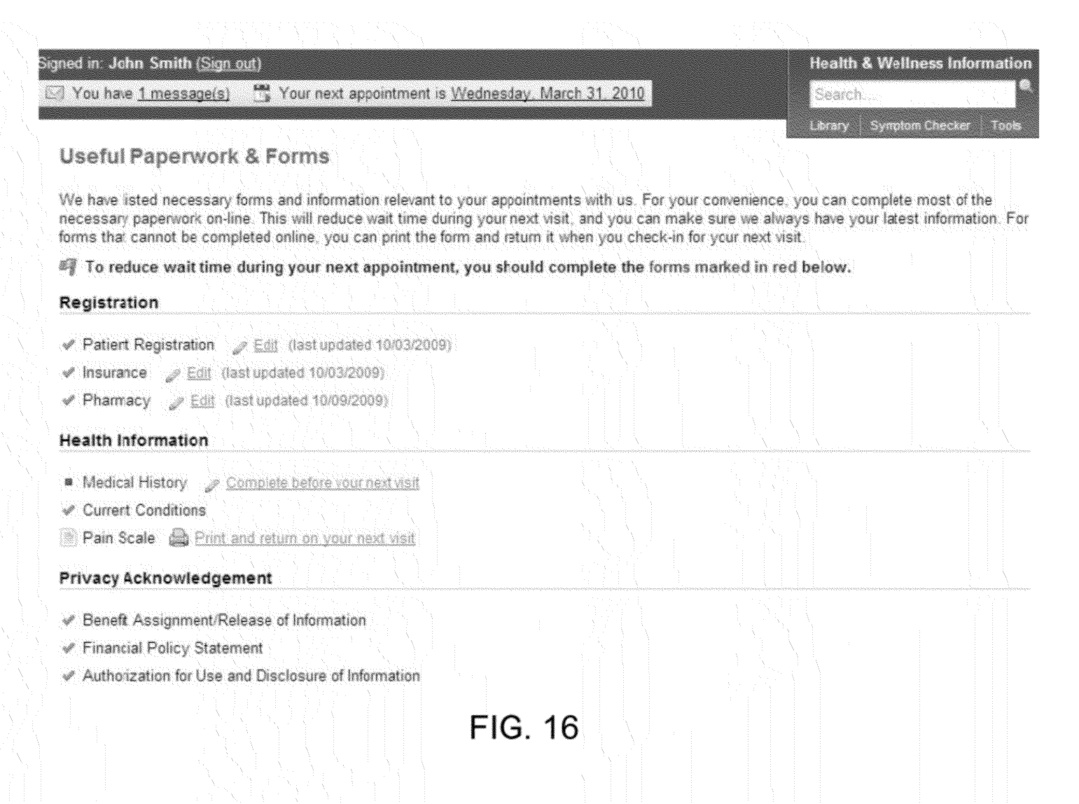

When a patient arrives at a medical practice for an appointment, the patient typically is required to fill out some information regarding their current health status, billing related information, insurance information, etc., during the visit to the medical practice. Applicants have recognized that at least a portion of this process may be expedited by enabling patients (or authorized third party users) to electronically enter at least some of this information into medical forms prior to a scheduled appointment via web portal 230 as shown in FIG. 16. In some embodiments web portal 230 may be configured to enable a user to select one or more medical forms for entering information related to visit to a medical practice. At least some of the medical forms, when selected, may be completed by a user to provide the medical practice with current information, thereby reducing the amount of time needed to collect such information when the patient is at the medical practice.

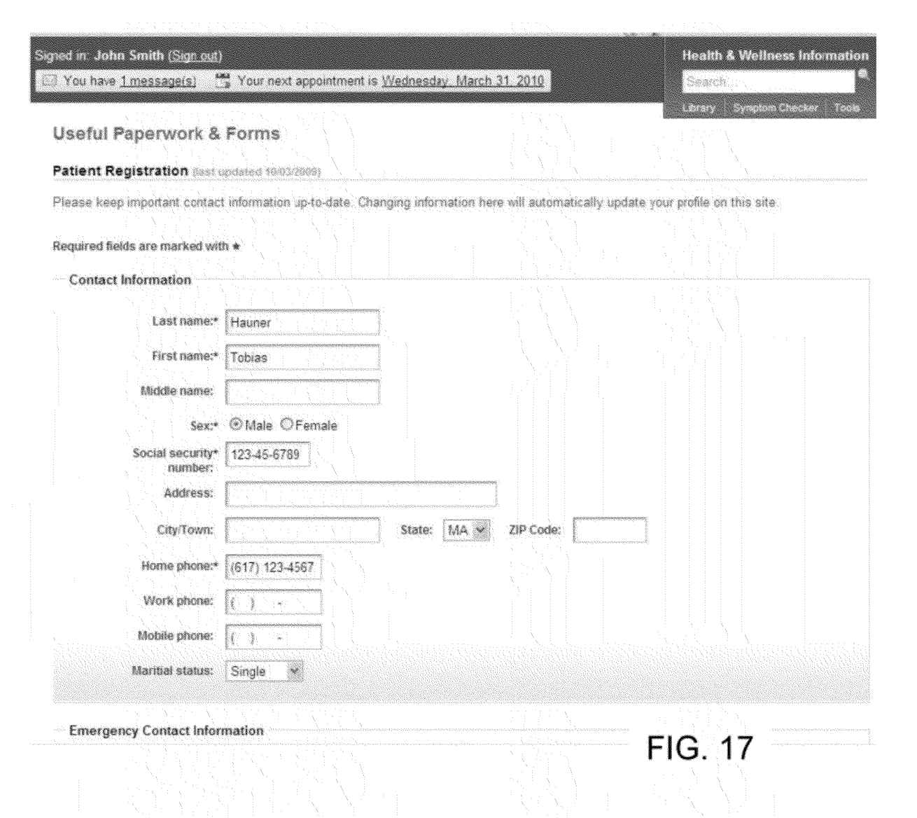

As shown in FIG. 17, a user may select a medical form to complete, and fields for the corresponding medical form may be displayed via web portal 230. In the exemplary form shown in FIG. 17, the user may enter information related to patient registration and the entered information may be stored in practice management system 100. By storing such information in practice management system 100, authorized medical practice personnel may access the information during a patient's visit to the medical practice as described in more detail below.

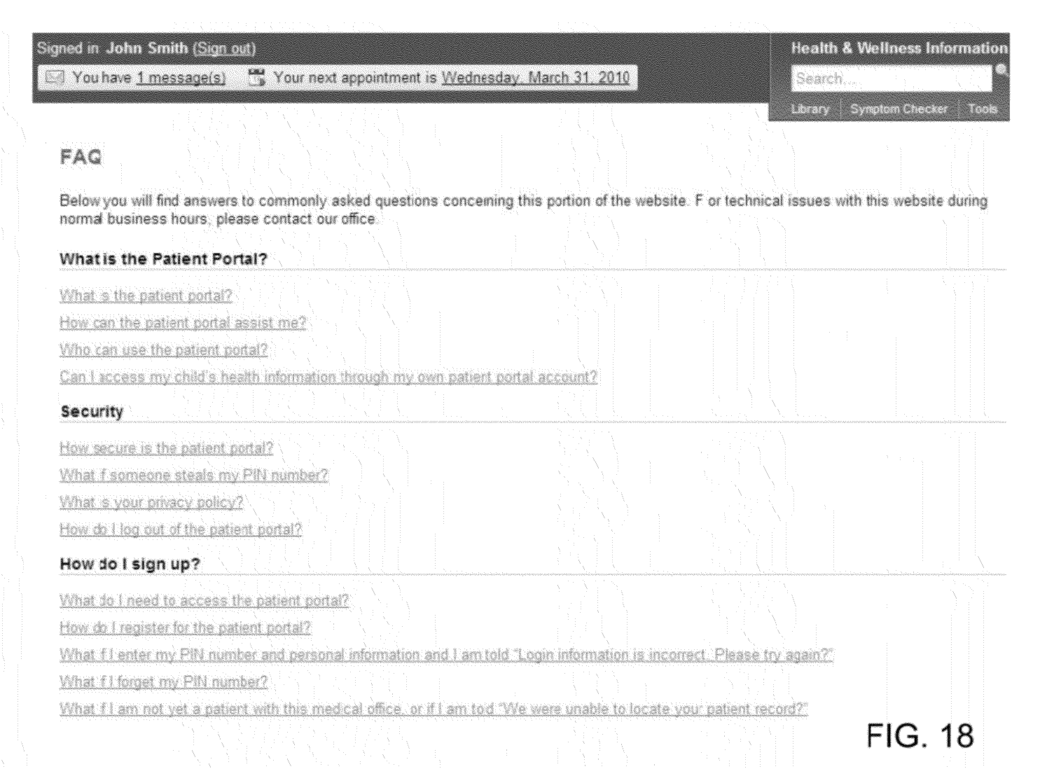

As shown in FIG. 18, in some embodiments, web portal 230 may be configured to display one or more frequently asked questions (FAQs) to enable a user to resolve questions relating to use of web portal 230. A user may interact with one or more of the FAQs to determine answers to questions frequently asked by other users of web portal 230, which may enable the user to quickly resolve a question without having to contact personnel at a medical practice, an administrator of practice management system 100, or another qualified person.

It should be appreciated that web portal 230 may include additional pages and functionality than those described above and embodiments of the invention are not limited in this respect. For example, web portal 230 may include one or more pages to enable a user to upload files or images to practice management system 100 to enable other users (e.g., medical practice personnel) to view the uploaded content. In some embodiments, web portal 230 may also include real-time chat and/or video interaction functionality to enable a user to ask medical practice personnel or other users information related to a patient's health care and/or how to use various aspects of web portal 230. As described above, information presented to a user via web portal 230 may be retrieved from practice management system 100, and information entered by a user using web portal 230 may be stored in practice management system 100 to enable authorized users of practice management system 100 to have a current view of a patient's medical information.

Portions of web portal 230 may also interact with communications management component 130 of practice management system 100 to facilitate a patient registration process, a billing collection process, and other processes related to a patient's health care at a medical practice. For example, communications management component 130 may send one or more automated messages to a patient to remind the patient that they may interact with web portal 230 to review and update information prior to a scheduled appointment at a medical practice, to pay an outstanding balance on a bill for medical services provided by the medical practice, or for any other suitable purpose.

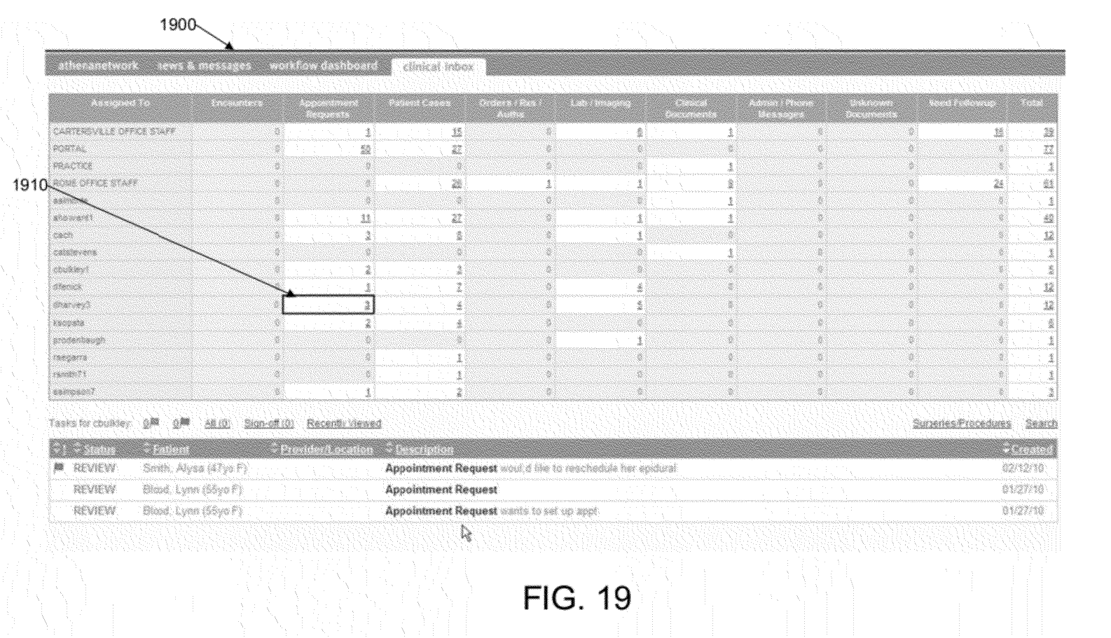

As described above, some embodiments are directed at facilitating the workflow of medical practice personnel by reducing an amount of medical practice resources expended during patient visits. This may be accomplished by using information entered in practice management system 100 by patients and other authorized users via web portal 230. Accordingly, some embodiments are directed to a user interface configured to display information in practice management system 100 that enables one or more users at a medical practice to interact with information in practice management system 100. FIGS. 19-39 represent portions of an exemplary user interface in accordance with some embodiments of the invention.

FIG. 19 shows a portion of a user interface displaying inbox 1900 in accordance with some embodiments of the invention. Inbox 1900 includes an overview of a plurality of tasks assigned to different staff members within a medical practice. For example, as shown in box 1910, staff member “dharvey3” of the “Rome Office” has been assigned three appointment requests on which action should be taken. In some embodiments, when a medical practice staff member logs in to a user interface associated with practice management system 100, the user interface may display an inbox similar to inbox 1900, but tailored for the particular staff member that has logged in to the user interface. However, in some embodiments, tasks for staff of the medical practice other than the currently logged in user may also be shown and embodiments of the invention are not limited in this respect.

The contents of inbox 1900 may be populated based, at least in part, on information in practice management system 100. For example, when a patient requests an appointment using web portal 230 or some other technique (e.g., by interacting with a live operator), a staff member at a medical practice may be assigned the task of following up with the patient who has requested the appointment. The assignment of a task to a medical practice staff member (e.g., a receptionist) may be displayed as a part of inbox 1900. The assigned staff member may interact with inbox 1900 to select a task in order to take action on the task. Although the discussion above relates primarily to appointment requests, it should be appreciated that inbox 1900 may display an assignment of other tasks to medical practice staff members including, but not limited to, lab/imaging tasks, phone messages, clinical documents, and any other tasks (e.g., patient cases) that may be assigned to a staff member of a medical practice based on information stored in practice management system 100.

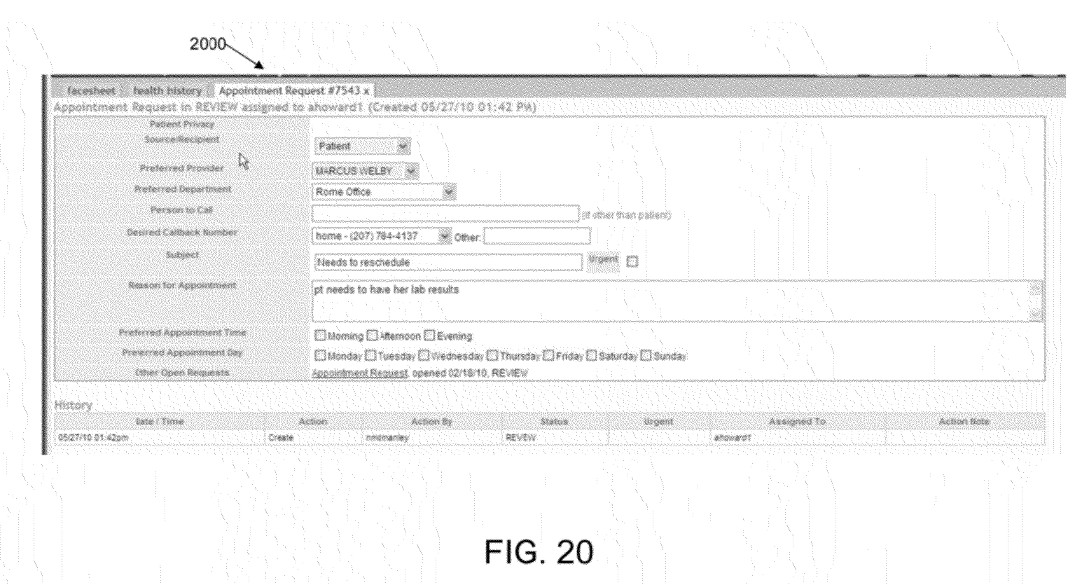

Medical practice personnel may interact with inbox 1900 to select a task for completion. For example, as shown in FIG. 20, a user has selected an appointment request 2000, which a patient has entered via web portal 230. Although exemplary appointment request 2000 is formatted in a similar manner to the appointment request view shown in FIG. 12 of web portal 230, embodiments of the invention are not limited in this respect, and appointment requests may be displayed on a user interface for medical practice personnel in any suitable manner. Upon selecting appointment request 2000, the user may take appropriate follow-up action to schedule the patient for an appointment based on the request and scheduling availability at the medical practice. For example, appointment request 2000 indicates that the patient would like to reschedule a previously scheduled appointment and the request provides a phone number for contacting the patient to reschedule the appointment. The user at the medical practice may call the patient to reschedule the appointment and/or the user may send a message to the patient at a stored email address, via a text message, and/or through web portal 230 depending on patient preferences stored in practice management system 100. By communicating with patients though practice management system 100 rather than using conventional telephone or mail communication techniques, the process of scheduling appointments is facilitated and the number of no-shows to a medical practice may be reduced.

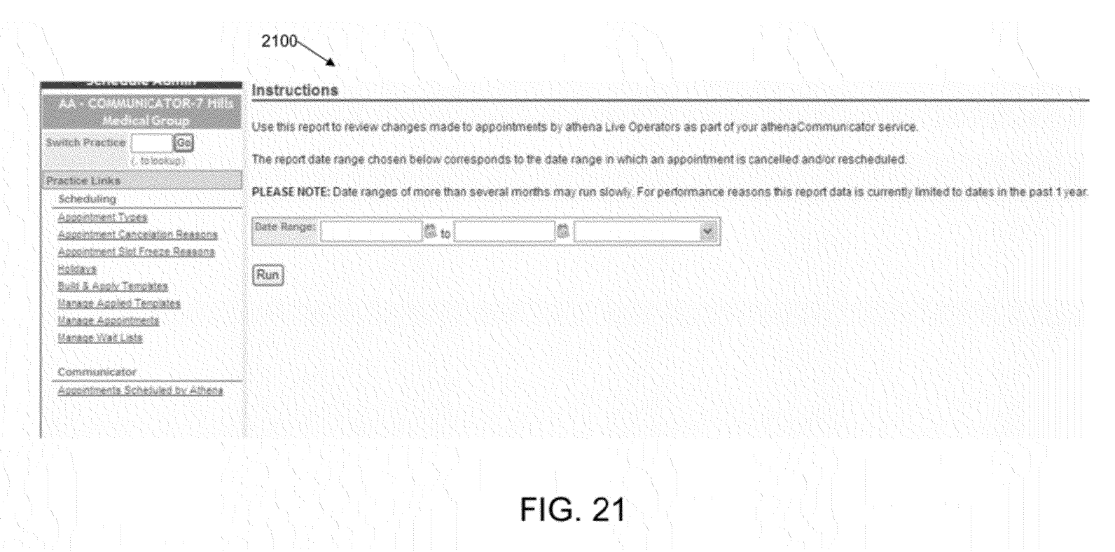

As described above, patients may interact with web portal 230 to request appointments at a medical practice. Patients may then wait for a confirmation of their appointment request from a person at the medical practice. Alternatively, in some embodiments, a patient may request an appointment from a live operator associated with the practice management system 100 rather than a staff member of the medical practice and the live operator may schedule the appointment on behalf of the medical practice. For example, a patient may interact, either through web portal 230 or otherwise, with live operators component 220 of communications management component 130 to schedule an appointment at a medical practice. In such embodiments, live operators associated with practice management system 100 may have access to the medical practice's appointment schedule to facilitate the scheduling of an appointment. However, in some instances, a live operator may merely help a patient fill out an appointment request on web portal 230 without actually scheduling an appointment for the patient. As shown in FIG. 21, appointments scheduled, rescheduled, and/or canceled by a live operator in accordance with some embodiments of the invention, may be reviewed by a staff member at a medical practice using review page 2100. In some embodiments, review page 2100 may be configured to enable a user at a medical practice to search a time range during which the user would like to review all appointments changed by a live operator. In response, a query may be sent to practice management system to retrieve all such interactions between a live operator and a scheduling component of practice management system 100 during the selected time period.

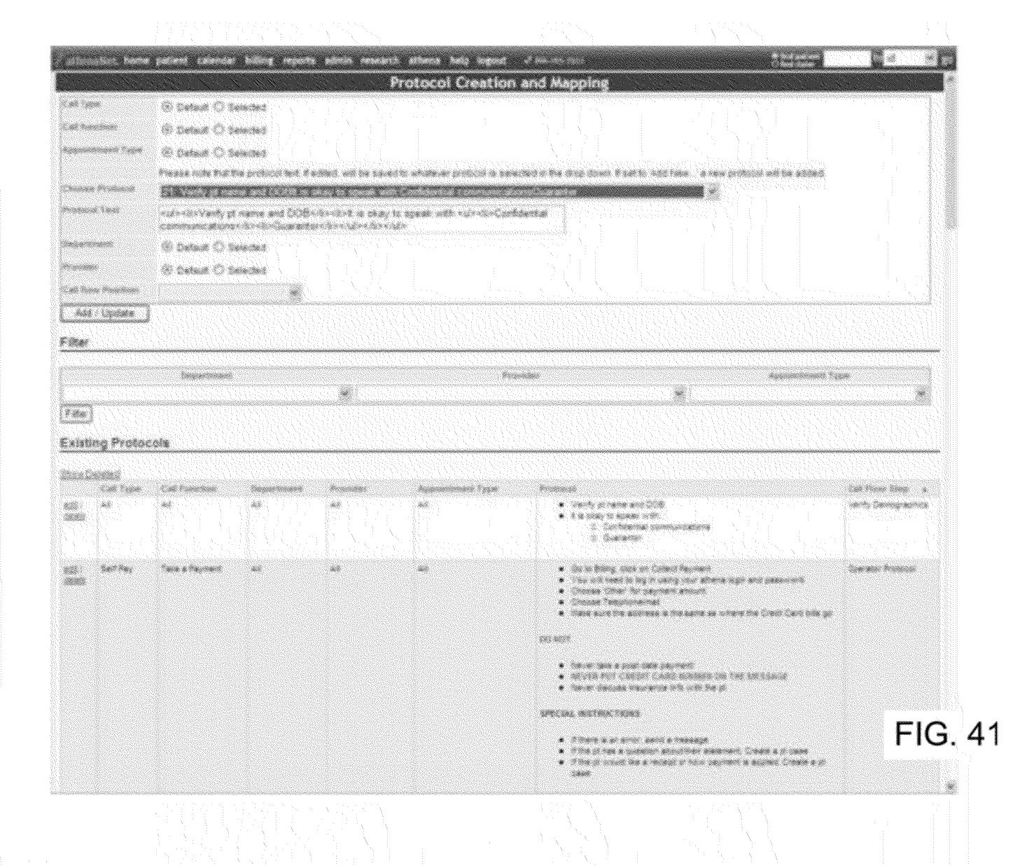

In some embodiments, an interaction between a live operator and patient may be facilitated through the use of one or more operator protocols, which help a live operator effectively handle a variety of interactions with patients including, but not limited to, collecting payments and scheduling or rescheduling patient appointments in accordance with preferences of a medical practice. An exemplary page for creating an operator protocol in accordance with some embodiments of the invention is illustrated in FIG. 41. A user may interact with one or more fields to define an operator protocol for one or more call scenarios that a live operator may encounter when interacting with a patient. Creating standardized protocols that live operators may use when interacting with patients may help to ensure that proper information is gathered from the patient during the interaction to complete a particular action such as rescheduling the patient's appointment.

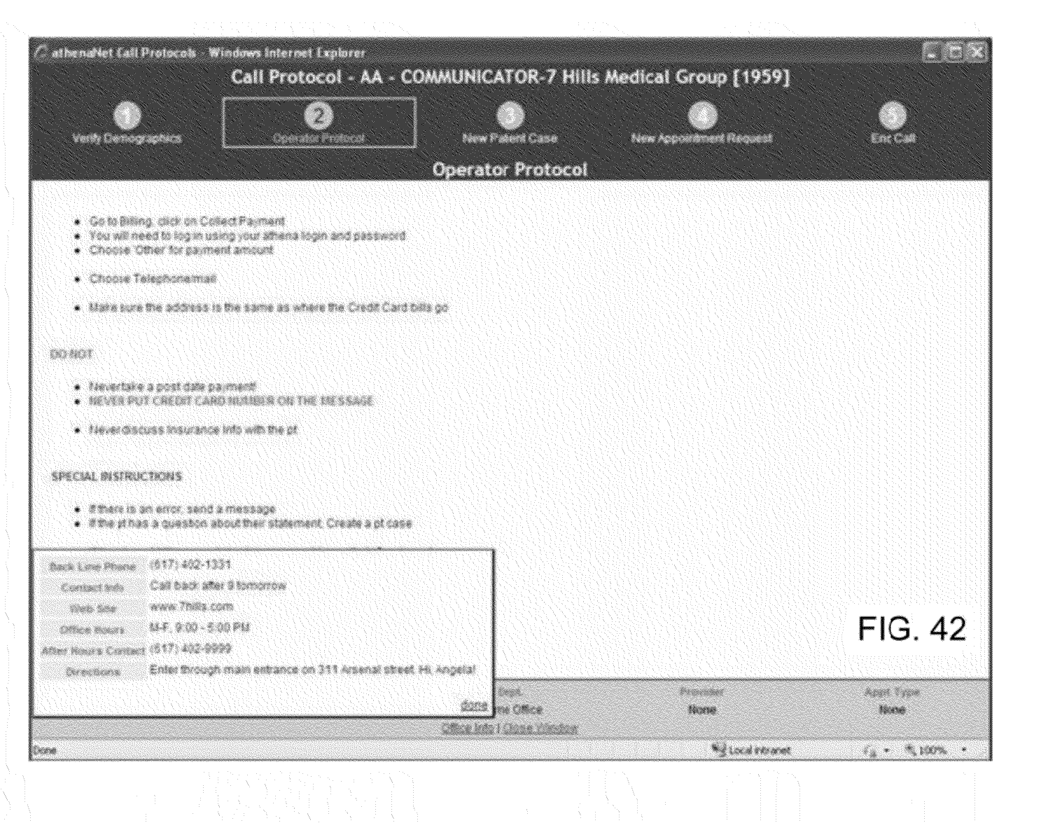

FIG. 42 illustrates an exemplary operator protocol page in accordance with some embodiments of the invention to facilitate an interaction between a patient and a live operator. As discussed above, when a patient requests to communicate with a live operator, a scheduling component (or other component) of the practice management system may route a patient's communication to a live operator in response to receiving the request. In some embodiments, in response to routing the communication to a live operator, the operator may be presented with an operator protocol page, an example of which is illustrated in FIG. 42.

The operator protocol page may include one or more types of information that help the live operator interact with the patient to perform a task such as submitting a payment or rescheduling an appointment. For example, the operator protocol page may include information stored by the practice management system, wherein the information is related to the patient with whom they are interacting. The information may include, but is not limited to, appointment information, billing information, demographic information, and contact information. The operator protocol page may also include information about the type of communication (e.g., appointment reschedule, process payment) and/or instructions that guide the live operator through the call to ensure that the appropriate information is retrieved from the patient to complete a particular task.

In some embodiments, operator protocol page may be generated based, at least in part, on information stored by the practice management system in response to receiving an indication that the patient has requested to communicate with a live operator. The generation of operator protocol page may be performed in any suitable manner and embodiments of the invention are not limited in this respect. For example, live operators component may interact with one or more components of the practice management system to retrieve data, wherein the data to be retrieved is determined based, at least in part, on a type of communication initiated by the patient. In some embodiments, the live operator may be able to interact with operator protocol page or some other page presented by the practice management system to perform one or more tasks associated with a communication with a patient.

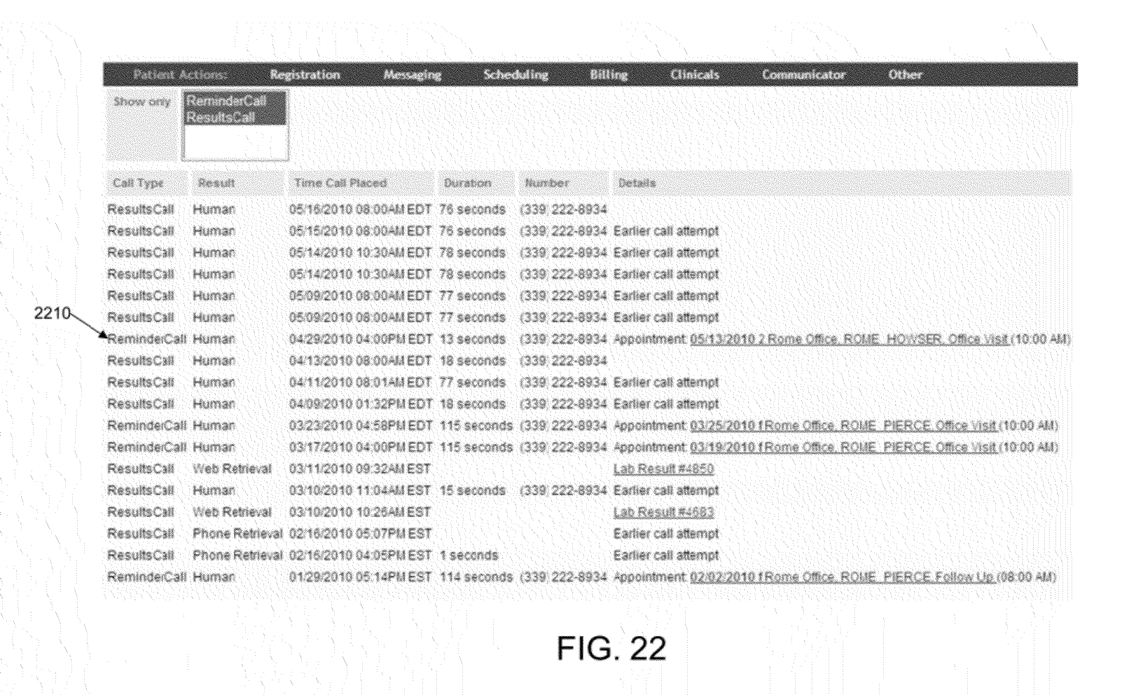

As described above, communications management component 130, in accordance with some embodiments, may be configured to send automated messages to patients for a variety of reasons including appointment reminders, payment reminders, and transmission of test results. In some embodiments, users at a medical practice may interact with a user interface to view one or more automated messages sent to patients by communications management component 130. FIG. 22 shows an exemplary report generated by practice management system 100 that displays automated calls sent by communications management component 130 on behalf of a medical practice. Such a report may provide a medical practice with a useful audit trail regarding a series of calls or messages (via web portal, email, text message, etc.) sent to a patient, and the manner in which the patient responded to the messages. For example, as shown in entry 2210, on Apr. 20, 2010 at 4:00 PM, communications management component 130 sent an automated call to phone number (339) 222-8934 to confirm an appointment schedule for a patient on May 13, 2010 at 10:00 AM. The result of the communication was a positive confirmation of the appointment by the patient who answered the automated call.

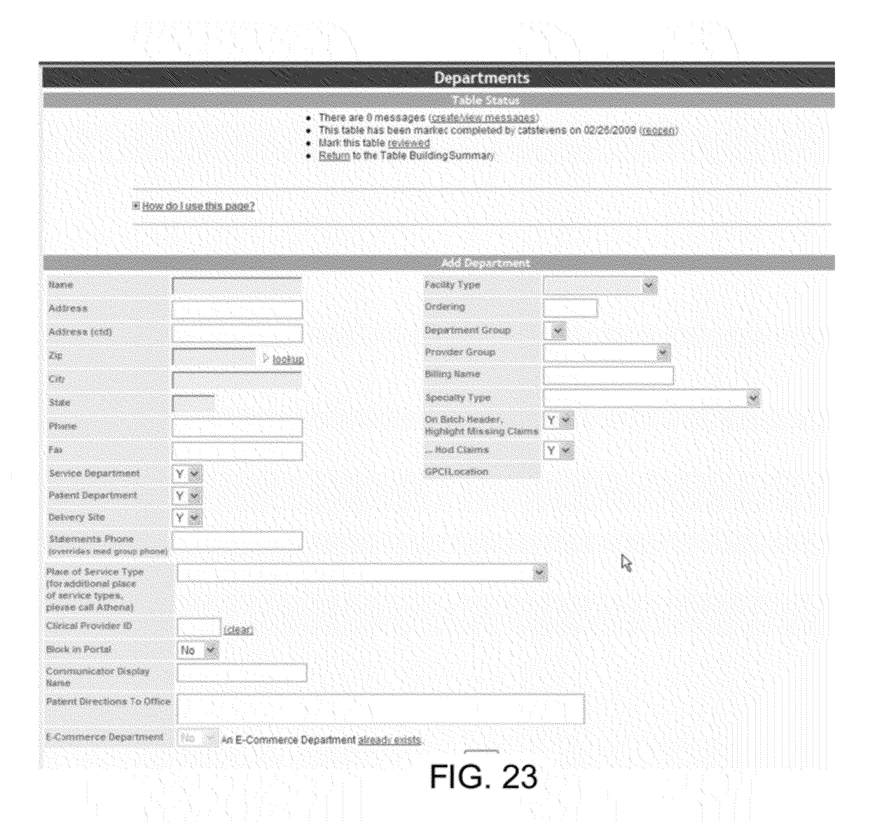

Different medical practices that use practice management system 100 may want communications with patients to be handled in particular ways that are specific to the medical practice. For example, a large hospital may want to restrict patients from scheduling appointments with certain departments in the hospital via web portal 230. In some embodiments, a user at a medical practice may configure department communication parameters for communications management component 130 using a portion of a user interface as shown in FIG. 23. In addition to blocking patient access to aspects of the department via web portal 230, in some embodiments, other aspects of a department may also be configured as shown in FIG. 23 including, but not limited to, contact information for the department and directions to the department (e.g., if different from the medical practice).

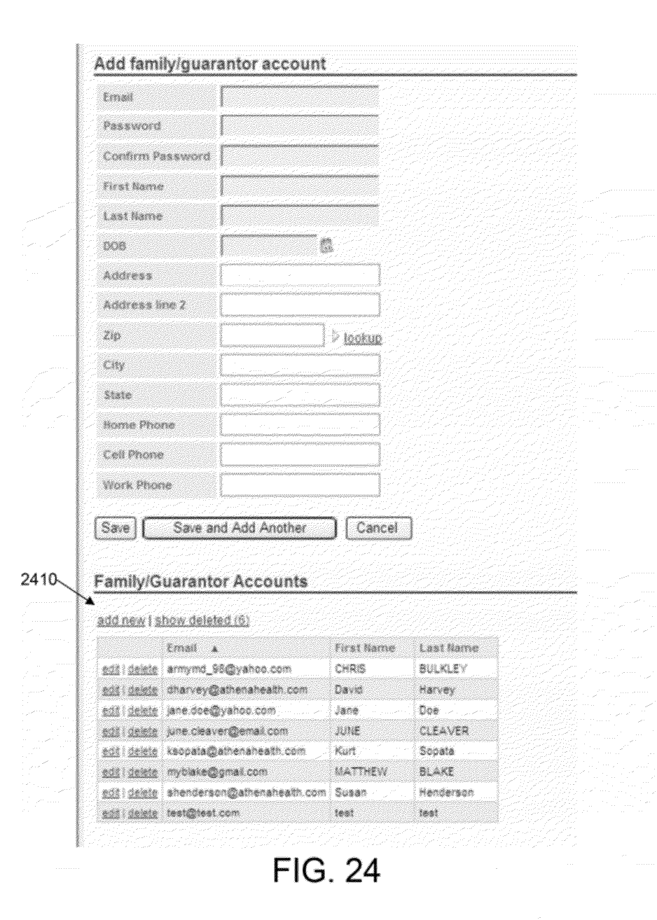

In some embodiments, a patient may request that a third-party (e.g., a family member or guarantor) be provided access to the patient's medical information available as part of practice management system 100. As described above, a patient may grant access to a third-party via web portal 230. Additionally, in some embodiments, an authorized user at a medical practice and/or a live operator of practice management system 100 may add and/or manage third-party accounts for a patient using a portion of a user interface, as shown in FIG. 24. An authorized user may interact with such a user interface to enter information about the third-party user including the third-party's relationship to the patient, contact information for the third party, and login credentials for the third party to enable the third party to interact with web portal 230, as described above. The user interface may also include a summary 2410 of all third-party accounts associated with a particular patient to enable authorized users and/or administrators of practice management system 100 to manage and restrict access to the patient's health information stored in practice management system 100.

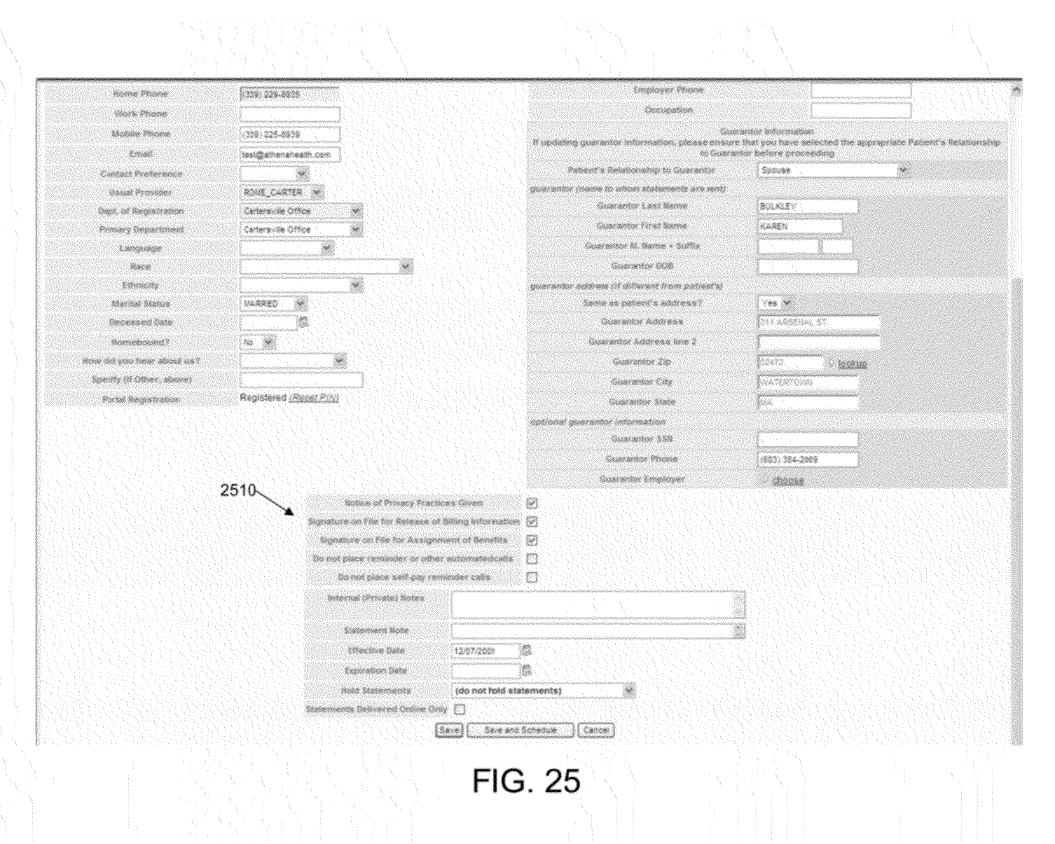

FIG. 25 shows an administrative page that enables a user at a medical practice to configure various aspects of communications between the medical practice and patients of the medical practice. For example, FIG. 25 includes section 2510 that describes privacy preferences for a patient of the medical practice including, but not limited to, whether the patient wants to receive automated messages from communications management component 130.

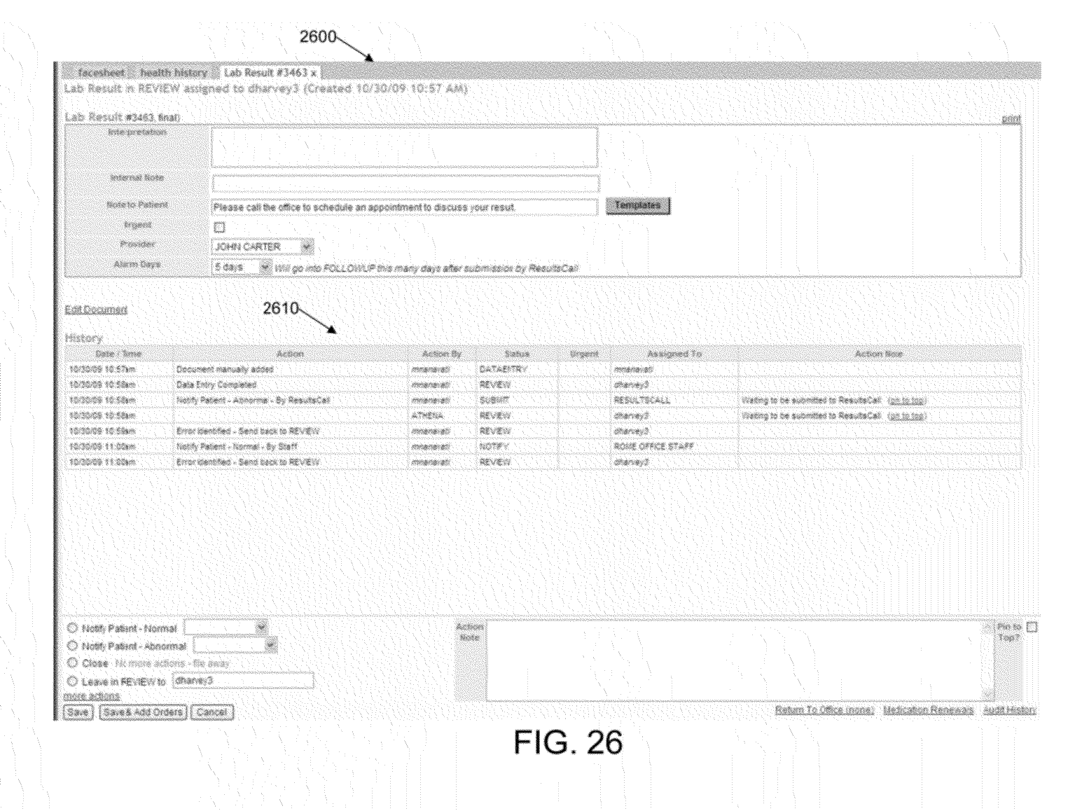

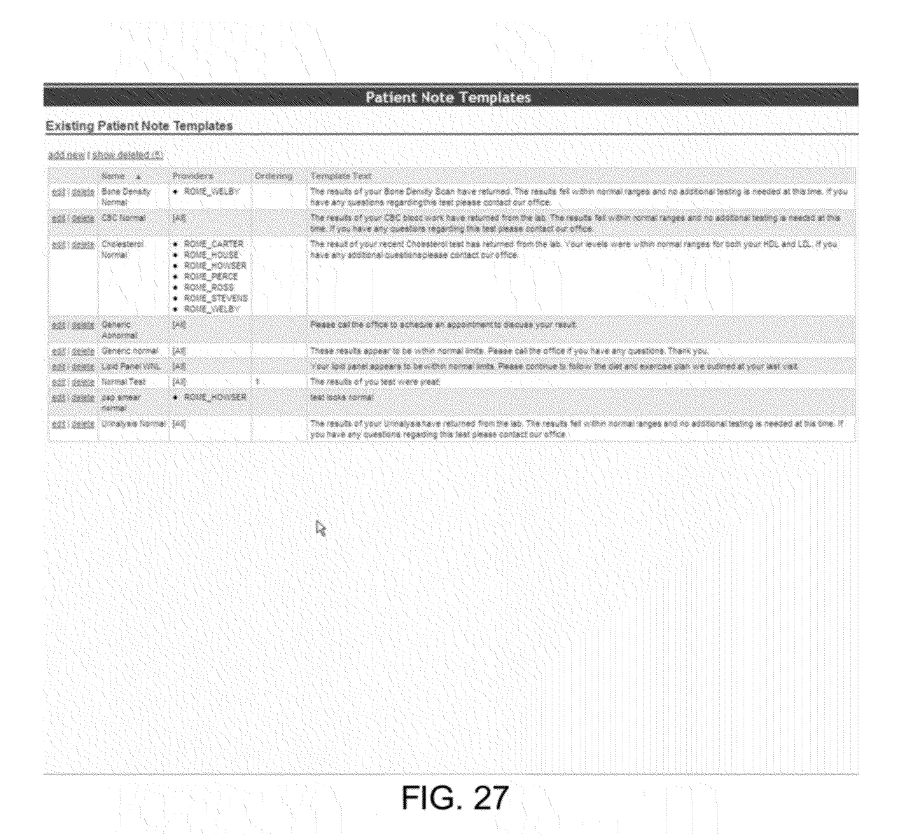

FIG. 26 illustrates an example of a test results page 2600 displaying a test result that may be transmitted to a patient using communications management component 130. In some embodiments, an audit trail 2610 related to actions taken by individuals with respect to the test result may be stored in practice management system 100 and indicated on a portion of the user interface as shown in FIG. 26. Users at a medical practice may interact with one or more fields on test results page 2600 prior to instructing communications management component 130 to send the test result to the corresponding patient. Information added to the one or more fields on test results page 2600 may be text entered by a physician or other qualified individual at the medical practice. As shown in FIG. 27, practice management system 100 may store common text strings often used by physicians at the medical practice to describe test results, and a physician or other qualified individual may select one or more of the stored text strings when editing the one or more fields on test results page 2600.

FIG. 27 shows that practice management system 100 may store different text strings or “templates” for different types of test results routinely encountered by a medical practice. By enabling physicians to select one of the templates stored by practice management system 100 rather than requiring the physician to enter the entire text each time, significant time savings on behalf of the physician may be achieved. After a physician has selected one of the templates, the physician may further modify the wording in the template, if necessary, prior to instructing the communications management component 130 to send the test result to the patient on behalf of the medical practice.

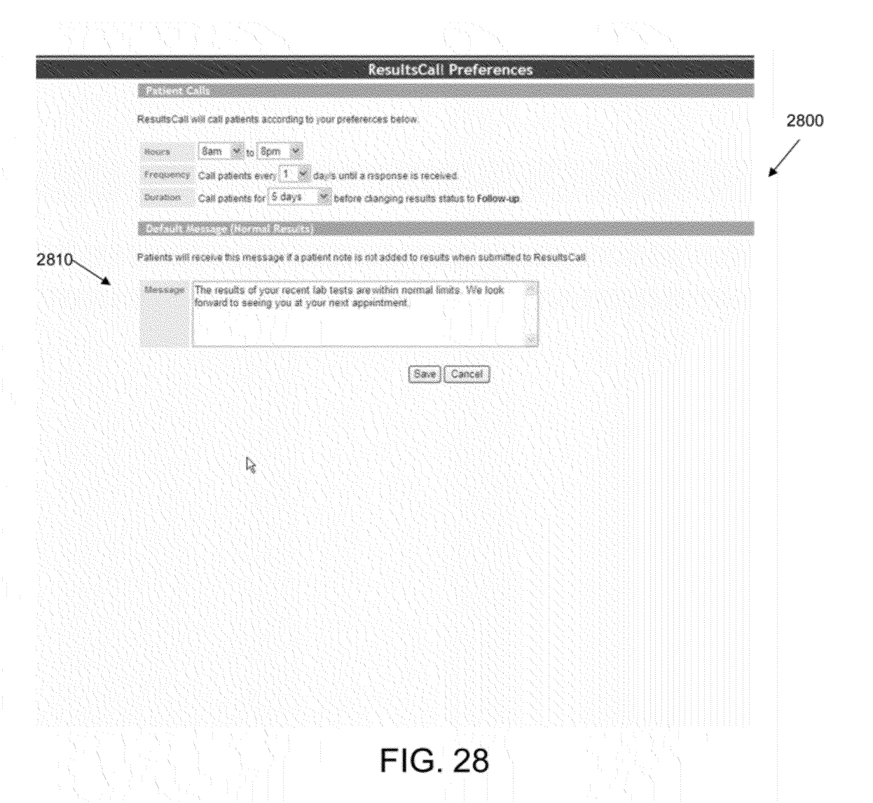

In some embodiments, users at a medical practice may interact with a portion of the user interface to configure communications management component 130 to send automated messages to patients of the medical practice only at certain times. As shown in FIG. 28, a user may interact with portions of messaging preferences page 2800 to specify preferences for contacting patients using communications management component 130 of practice management system 100. Time based preferences may include, but are not limited to, time of day, frequency of sending messages, and duration before which personnel or a live operator should follow-up with a patient if a response to an automated message has not been received. In some embodiments, messaging preferences page 2800 may include a section 2810 for specifying a default message that may be used by communications management component 130 if there is no other text (e.g., a template shown in FIG. 27) associated with an automated message scheduled to be sent to a patient by communications management component 130.

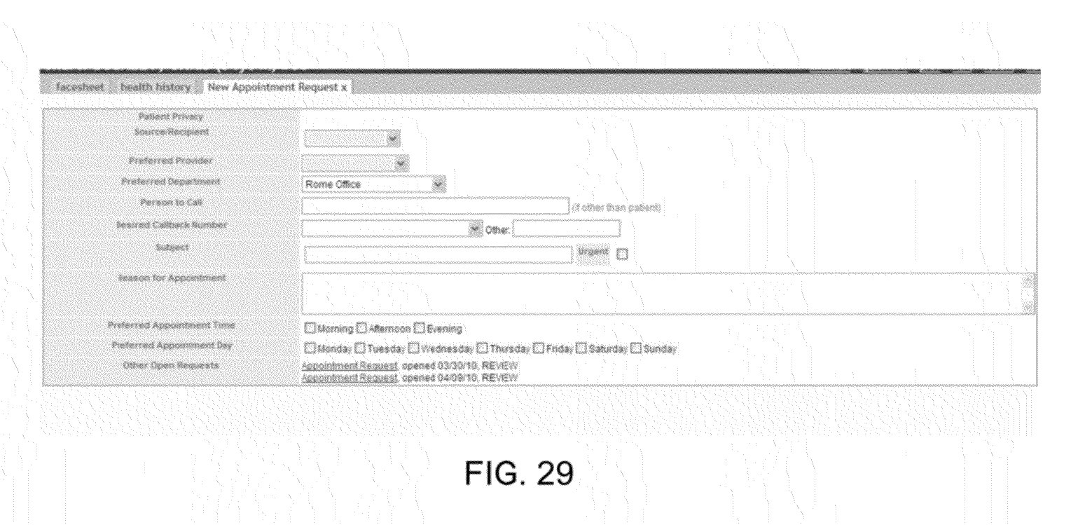

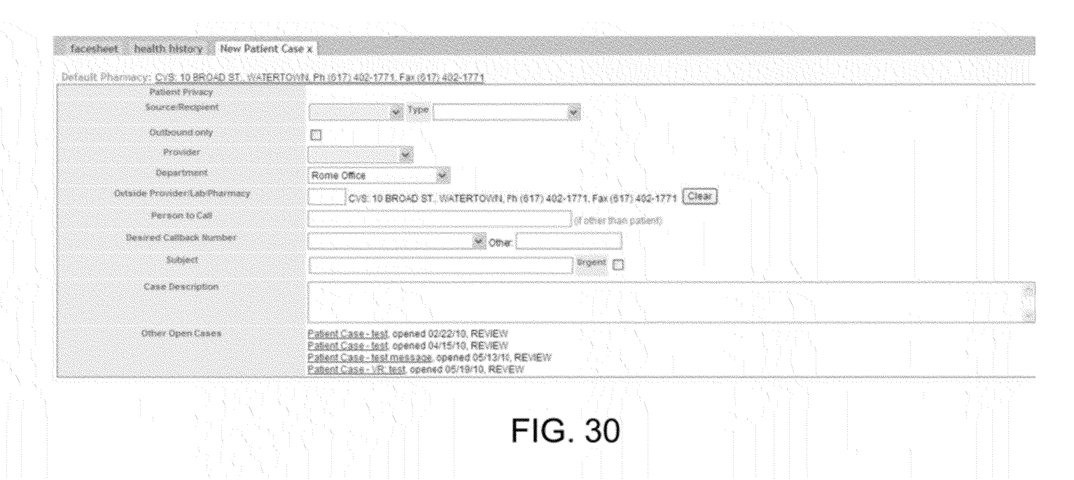

As described above, some embodiments of the invention include live operators component 220, which provides live operator support for a medical practice to enable patients to interact with the medical practice during times when the medical practice is normally closed and/or when the call volume at the medical practice is high. FIGS. 29 and 30 illustrate portions of a user interface that a live operator may use to facilitate interactions with a patient on behalf of a medical practice. FIG. 29 shows an appointment request page that a live operator may use to schedule an appointment for a patient at the medical practice. In some embodiments, the appointment request page used by a live operator to schedule appointments may be similar to an appointment request page used by a patient via web portal 230 to schedule an appointment, although embodiments are not limited in this respect.

FIG. 30 shows a patient case page that a live operator may interact with to enter information received during a live operator communication with a patient that is not related to scheduling an appointment. For example, a live operator may interact with a patient case page to enter information when a user has billing questions regarding their account and these billing inquiries may be forwarded to the appropriate person responsible for billing at the medical practice (e.g., as shown in inbox 1900). It should be appreciated, however, that inquiries other than billing inquiries may also be addressed by a live operator using a patient case page, such as that shown in FIG. 30, and embodiments of the invention are not limited in this respect.

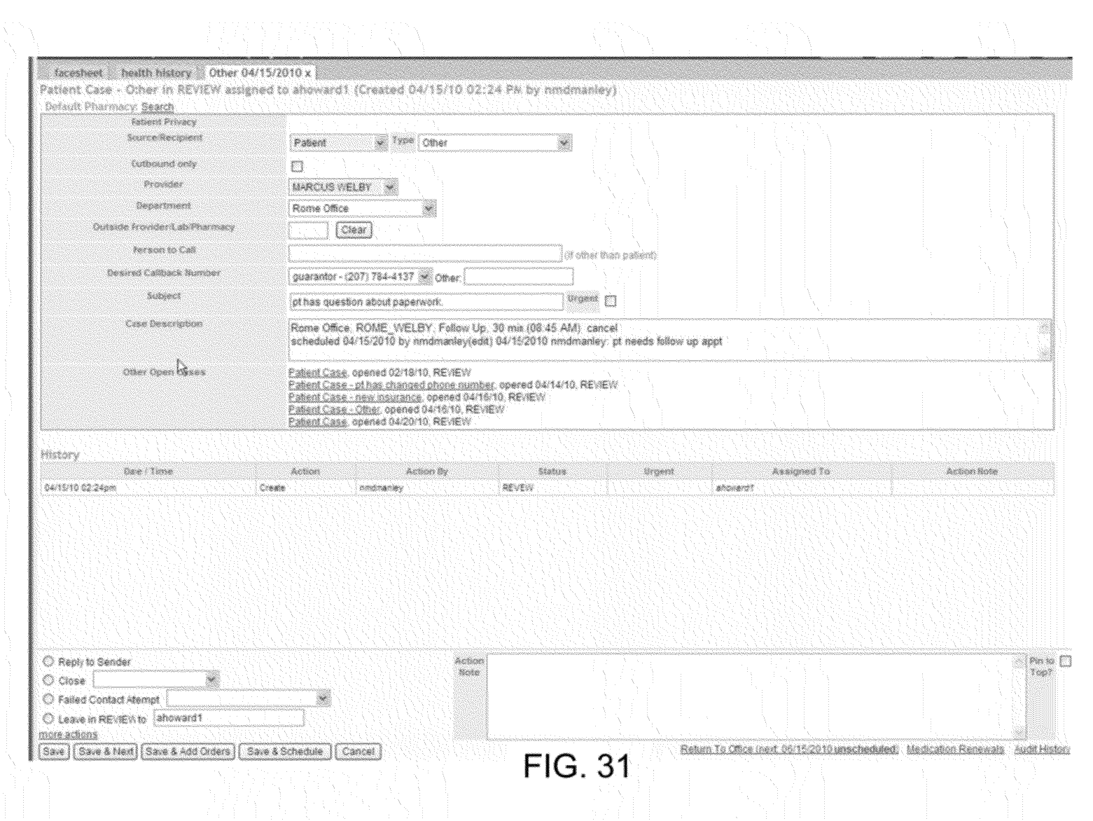

FIG. 31 shows a portion of the user interface that a user at a medical practice may interact with to review patient cases entered by a live operator as described above. In addition to displaying information that has been entered by a live operator, the user interface may also display a history of actions performed on the patient case to enable the user at the medical practice to better understand how to resolve the patient's question. For example, as shown in FIG. 31, a patient interacted with a live operator because the patient had a question regarding paperwork. The live operator entered this information into a patient case page (e.g., see FIG. 30), and the information was stored in practice management system 100 to be reviewed by a user at the medical practice. Upon accessing the user interface, a user at the medical practice may see that the patient case has been assigned to them, and they may open up the patient case to reveal the page shown in FIG. 31. After reviewing the information on the patient case page, the user at the medical practice may follow up with the patient using any suitable technique (e.g., by sending a message via web portal 230, calling the patient, or sending a text message or email to the patient) to resolve the patient's question regarding paperwork.

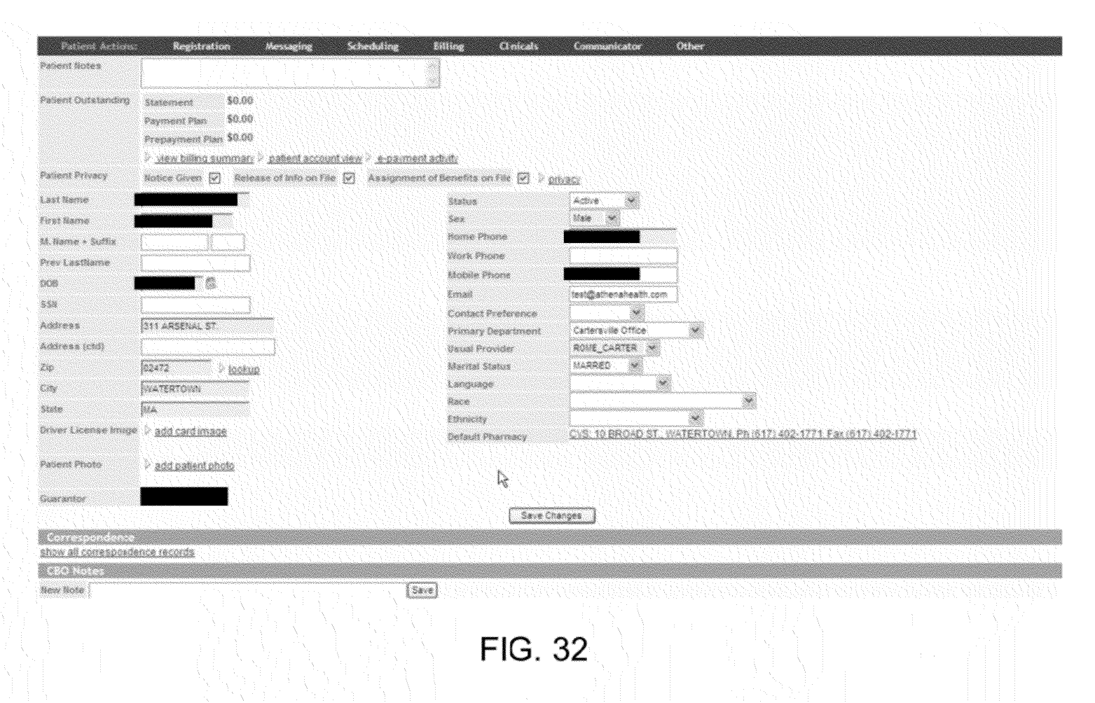

In some embodiments, the practice management system 100 may present a user interface configured to enable a user at a medical practice to register a new patient with the medical practice as shown in FIG. 32. The user at the medical practice may interact with the user interface to enter information about the new patient including, but not limited to, demographic information, insurance information, and contact information. In some embodiments, a patient may be able to self-register using web portal 230 as described above. However, in some embodiments, at least some interaction with a user at the medical practice may be required for registration as a new patient of a medical practice.

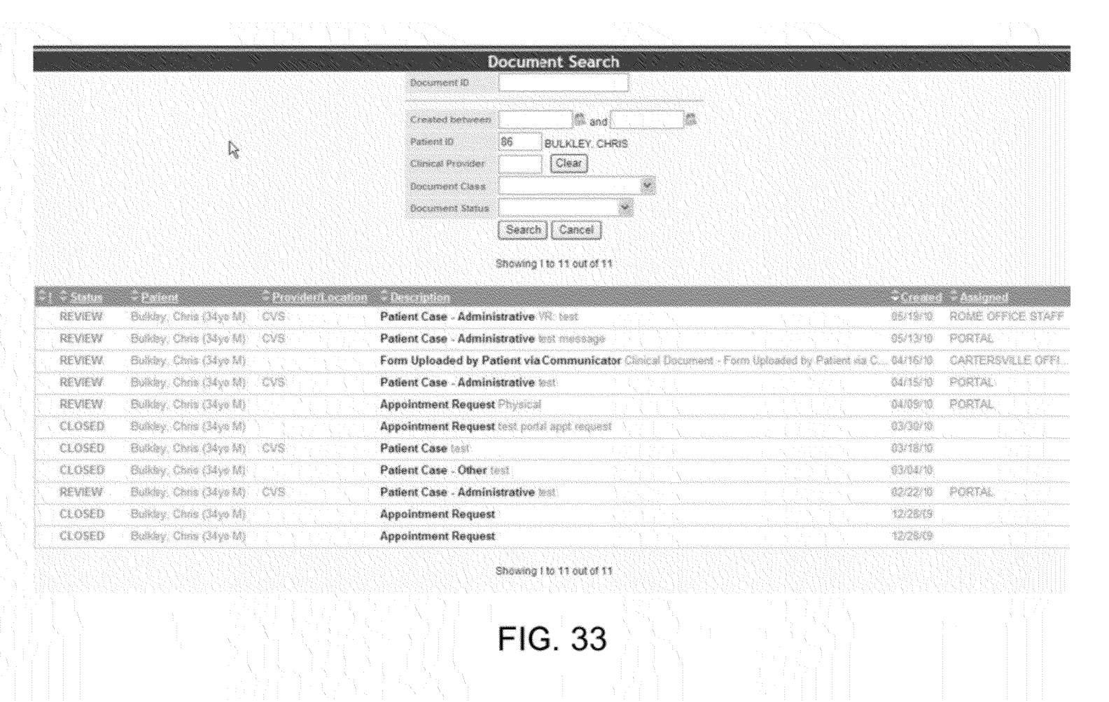

In some embodiments, users at a medical practice may interact with the user interface to search for previous user actions stored on practice management system 100 as shown in FIG. 33. For example, as shown in FIG. 33, a search engine may be employed to search for all previous actions stored on practice management system 100 related to a particular patient. In response to receiving such a request from a user, practice management system 100 may retrieve all records or “documents” that refer to previous interactions based on the specified search parameters in the request. Upon retrieving the results of the search, the user interface may display the results including, but not limited to, the status of each of the documents and other identifying information.

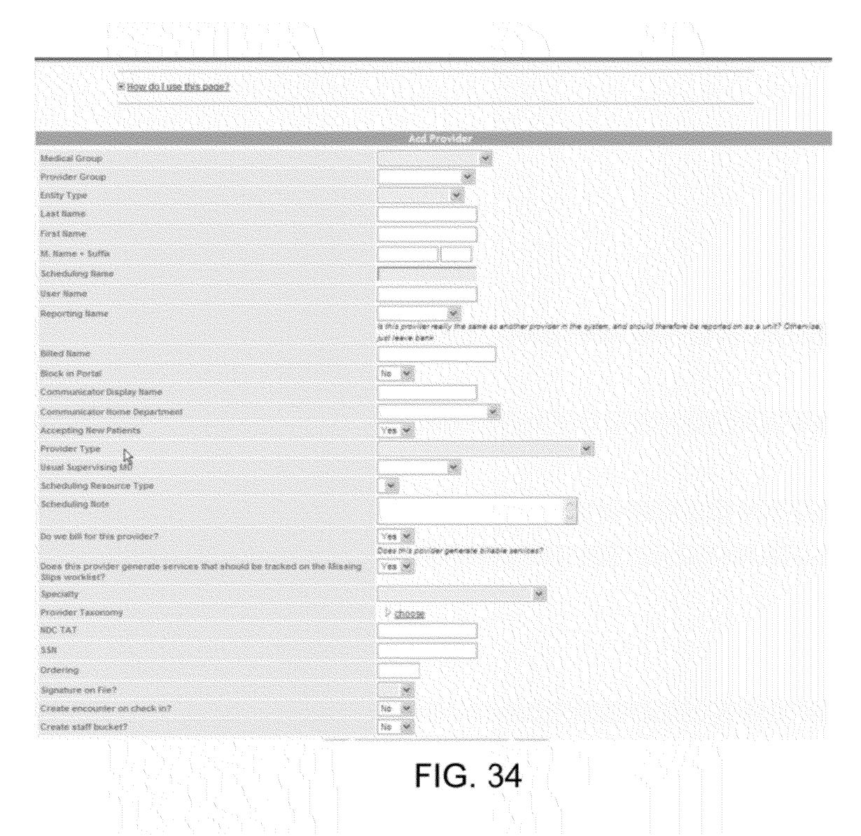

A user interface in accordance with some embodiments of the invention may include one or more provider configuration pages for configuring preference information for a medical practice as shown in FIG. 34. An administrator of practice management system 100 or other authorized user may interact with a provider configuration page to ensure that correct information is provided to patients (e.g., via web portal 230) regarding the medical practice and/or to ensure that the name of the medical practice is displayed properly to users of the medical practice when logged into a portion of the practice management system, as described above. For example, a user at the medical practice may indicate that the medical practice is not accepting new patients. Accordingly, patients using web portal 230 may be made aware that they should not submit new patient requests to the medical practice via web portal 230. Other aspects of medical practice configuration within practice management system 100 may also be configured using provider configuration pages and embodiments of the invention are not limited in this respect.

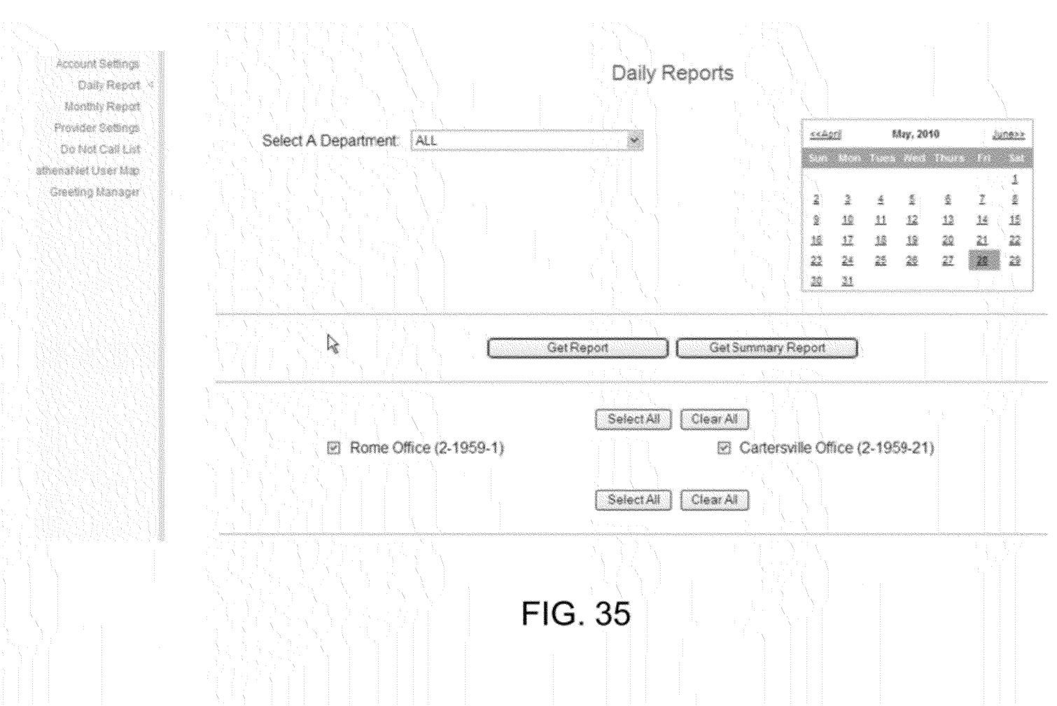

FIG. 35 illustrates a portion of a user interface that a user at a medical practice may interact with to produce one or more detailed reports regarding activity on practice management system 100. For example, a medical practice may have offices in multiple locations, and an administrator of the medical practice may want to review patient communications at each of the multiple locations in a report. The administrator may interact with a reports page such as that shown in FIG. 35 to generate such a report.

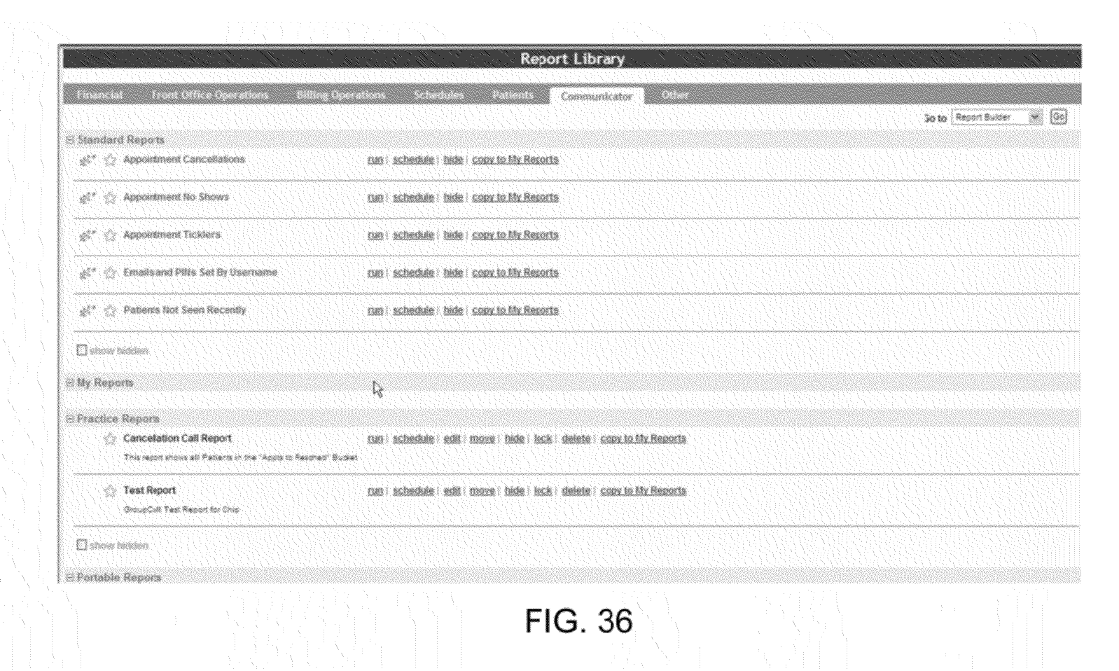

In some embodiments, an administrator or other authorized user may instruct practice management system 100 to generate reports at certain time intervals (e.g., daily, weekly, etc.) to include sets of patients or information that is of particular interest to the medical practice and such reports may be stored in a report library, as illustrated in FIG. 36. For example, a medical practice may want to generate a report for all patients who either cancelled their appointment or were no-shows within the past week, so that the identified patients may be contacted and rescheduled.

Alternatively, a medical practice may want to determine all patients at the medical practice who have not yet made an appointment for their annual mammogram screening in order to send a reminder for these patients to schedule an appointment. By generating such reports at regular time intervals, users at a medical practice can quickly identify which patients should be contacted for follow-up. Furthermore, since the report generation is linked with information stored in practice management system 100, the reports may be generated based on the most current information about the patients and their interactions with the practice management system 100.

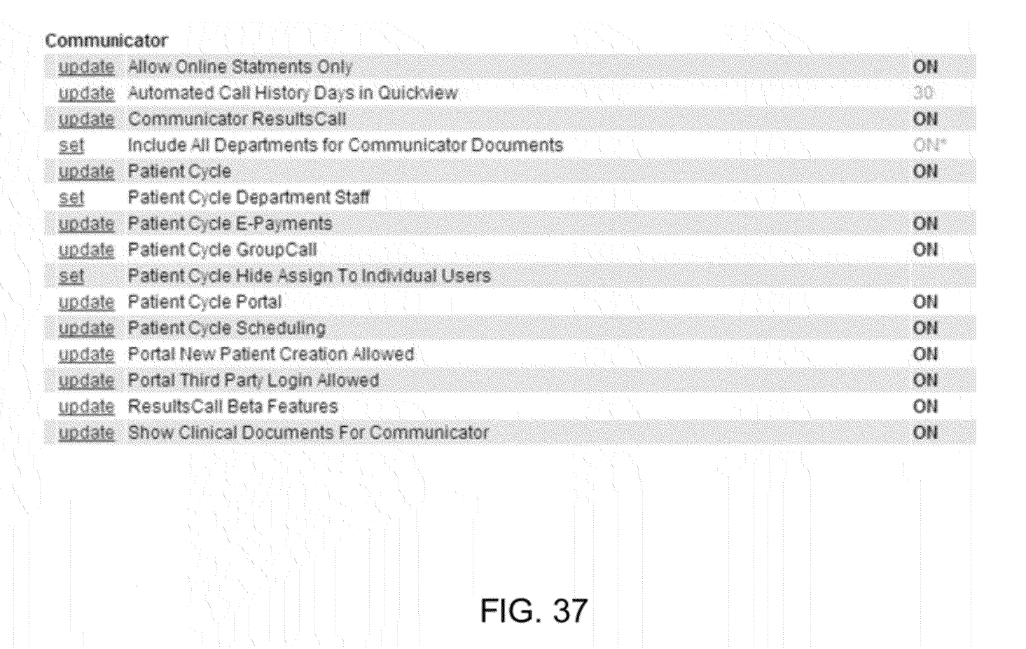

FIG. 37 shows an exemplary portion of a user interface that an administrator of practice management system 100 may interact with to set preferences for a medical practice. For example, the medical practice may want to restrict patient's access to portions of web portal 230 for certain reasons, and an administrator can place such restrictions by interacting with the medical practice's preferences page such as the page shown in FIG. 37. Although an example of restricting patient access to web portal 230 is discussed above in connection with FIG. 37, it should be appreciated that other ways in which a medical practice may be configured within practice management system 100 are also contemplated and embodiments of the invention are not limited in this respect.

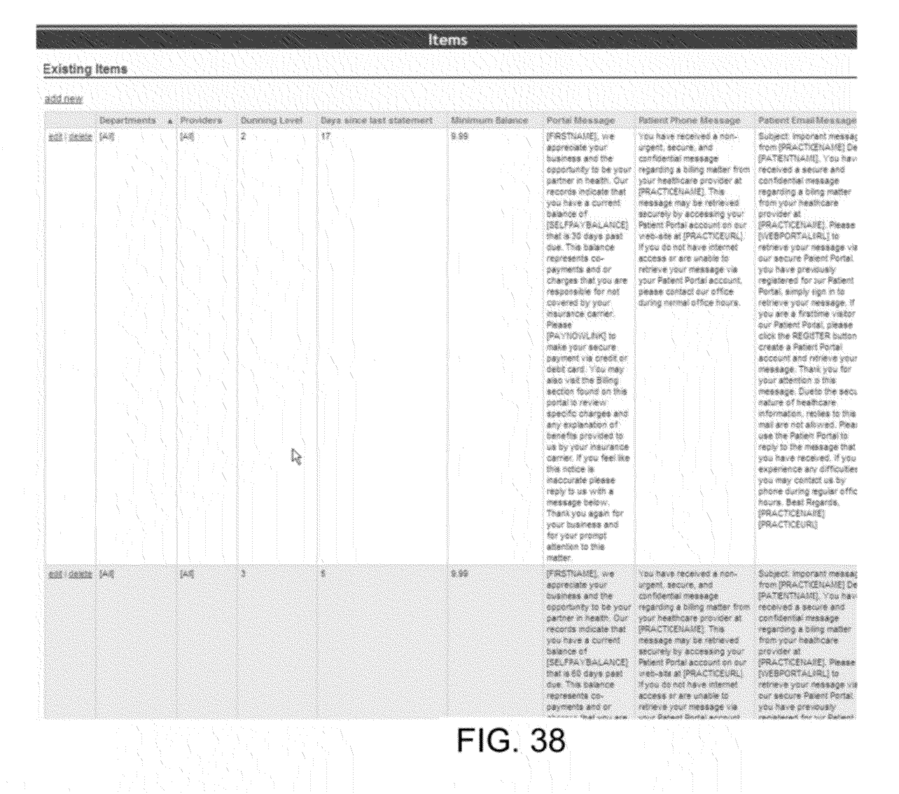

FIG. 38 shows an exemplary portion of a user interface that enables a user at a medical practice to view and/or edit scripting of automated messages sent to patients via communications management component 130. For example, a billing administrator at a medical practice may want to send different messages to patients depending on how many days past due their outstanding balance is, how much their minimum balance is, the method in which the message is to be sent (e.g., portal, phone, email, text), or any other suitable criteria. In some embodiments, scripted messages may include one or more links that, when selected, navigate to pages of web portal 230 that enable the user to take an action regarding the message (e.g., paying an outstanding balance on a bill using self-pay collections component 240).

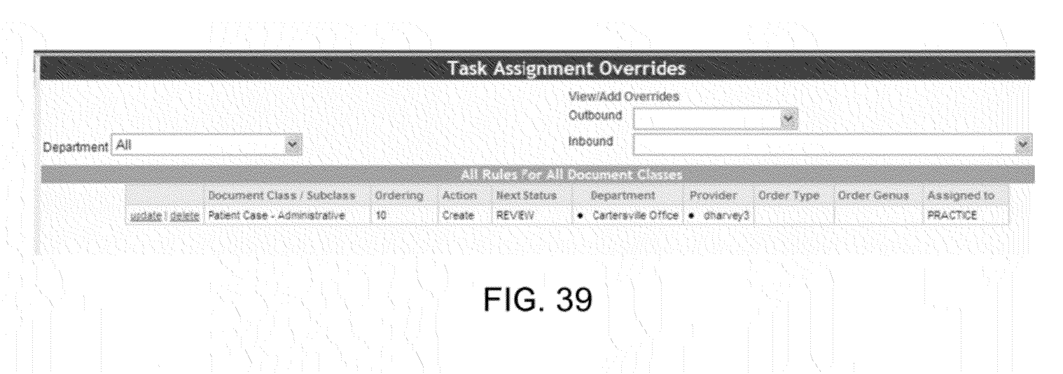

FIG. 39 shows a portion of a user interface that an administrator at a medical practice or associated with practice management system 100 may use to configure how to assign tasks to users at a medical practice as described previously. By redirecting tasks to the proper user at the medical practice, patient's inquiries may be addressed by the medical practice in an efficient manner.

As discussed above, in some embodiments, a scheduling component of practice management system 100 may be configured to enable an administrator at a medical practice to create and/or modify aspects of a scheduling calendar for the medical practice using an interactive scheduling interface. For example, an administrator at the medical practice may allow patients to schedule at least some appointments using web portal 230 and the availability of which timeslots are available for patients to schedule may be limited based, at least in part, on scheduling configuration information specified by the administrator at the medical practice and stored by the practice management system.

In some embodiments, an administrator at a medical practice may interact with a scheduling component of practice management system to create one or more appointment attributes used to facilitate scheduling a patient visit to the medical practice. Appointment attributes include, but are not limited to, appointment types, department identifiers, provider identifiers, and any combination thereof. The appointment attributes may be stored by the practice management system as scheduling configuration information and may be used to search a current schedule of a medical practice in response to a patient request.

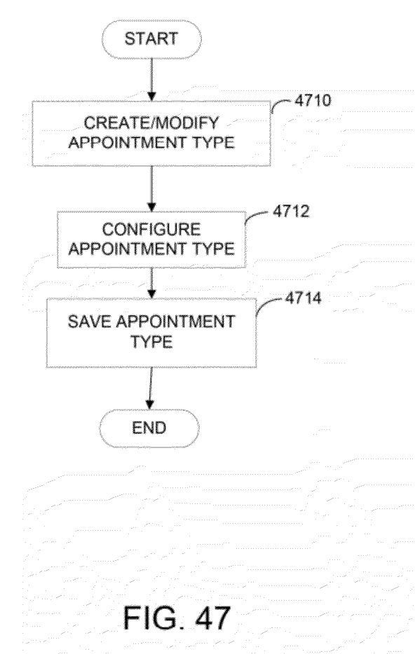

An exemplary appointment attribute that may be specified by an administrator at a medical practice is an appointment type. A process for creating an appointment type in accordance with some embodiments is illustrated in FIG. 47. In act 4710, an administrator at a medical practice indicates that an appointment type is to be created or an existing appointment type is to be modified. In response to receiving the indication to create/modify an appointment type, the process proceeds to act 4712, where the appointment type is configured by specifying one or more configuration options for the appointment type, as discussed in more detail below. After the administrator has specified the one or more configuration options for the appointment type, the process proceeds to act 4714, where the appointment type including the configuration options are stored by the practice management system 100 as scheduling configuration information.

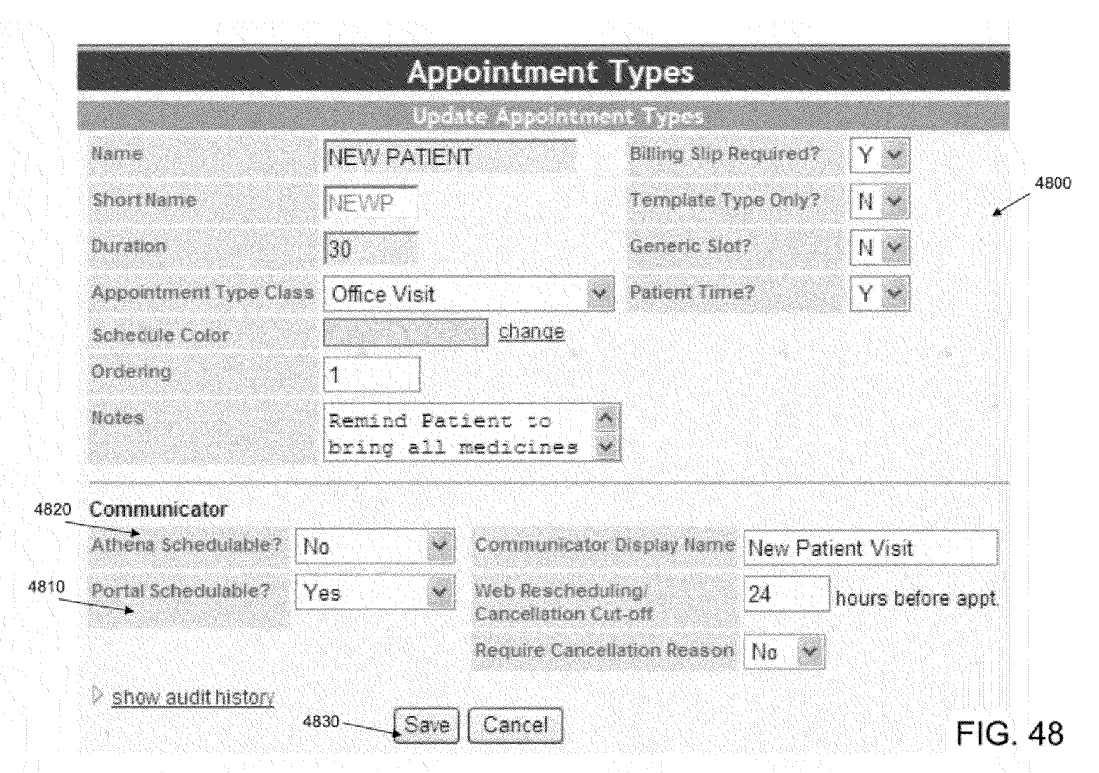

To facilitate the specification of configuration options for an appointment type, practice management system 100 may be configured to display to an administrator of a medical practice, an appointment types page 4800, an example of which is shown in FIG. 48. Appointment types page 4800 enables the administrator to specify and configure appointment types to associate with the appointment schedule for the medical practice. Any suitable type of appointment may be configured using appointment types page 4800. For example, different departments at the medical practice may specify appointment types specific to their department. Additionally, within a department, appointment types may be specified based on a particular provider within the department and appointments for different types of medical services may be configured and stored by practice management system 100. For example, an OB/GYN provider might allow patients to schedule appointments of type “OG/GYN” being associated with first configuration options, while a cardiologist might allow new patients to schedule an appointment of type “Cardio,” being associated with second configuration options.

Each appointment type created using appointment types page 4800 may be further configured by an administrator of the medical practice using one or more interactive fields on appointment types page 4800. For example, appointment types page 4800 includes patient portal selector 4810, which enables the administrator to specify whether patients can schedule appointments of the appointment type using web portal 230. As shown in the example of FIG. 48, other scheduling configuration information may also specified using appointment types page 4800. For example, the administrator may specify whether the appointment type is capable of being scheduled by a live operator associated with practice management system 100 by interacting with live operator selector 4820. An administrator may also establish a cutoff time after which scheduling and/or cancelling of an appointment by a patient using web portal 230 will not be allowed. In the example of appointment type page 4800, this cutoff time is shown to be 24 hours before the appointment, but it should be appreciated that any suitable cutoff time may alternatively be selected. To encourage patients not to repeatedly cancel appointments, the administrator may configure the appointment type to require a cancellation reason should a patient attempt to cancel an appointment using web portal 230 and/or using a live operator.

Other information for configuring an appointment attributes is also contemplated, and embodiments of the invention are not limited in this respect. For example, in addition to specifying configuration options regarding how an appointment of a particular appointment type may be scheduled, an administrator at the medical practice may also configure how the appointment type will be represented on an interactive scheduling page with which users at the medical practice, live operators, and patients may interact to schedule appointments having the appointment type. As shown in FIG. 48, an administrator at a medical practice may specify, among other things, the color with which the appointment type will be displayed in the interactive scheduling page, a duration of the appointment type, and notes associated with the appointment type.

Other configuration options including, but not limited to the options shown in FIG. 48 are also considered part of this disclosure. For example, an appointment type may be configured as a “generic” appointment type such that it may be associated with any available timeslot at the medical practice or within a department at the medical practice. Generic appointment types may be especially useful in systems that allow for open scheduling that does not restrict at least some timeslots in the schedule for the medical practice based on appointment type. After an administrator has finished specifying configuration options for the appointment type, the administrator may interact with save selector 4830 to store on practice management system 100 the configuration for the appointment type as schedule configuration information.

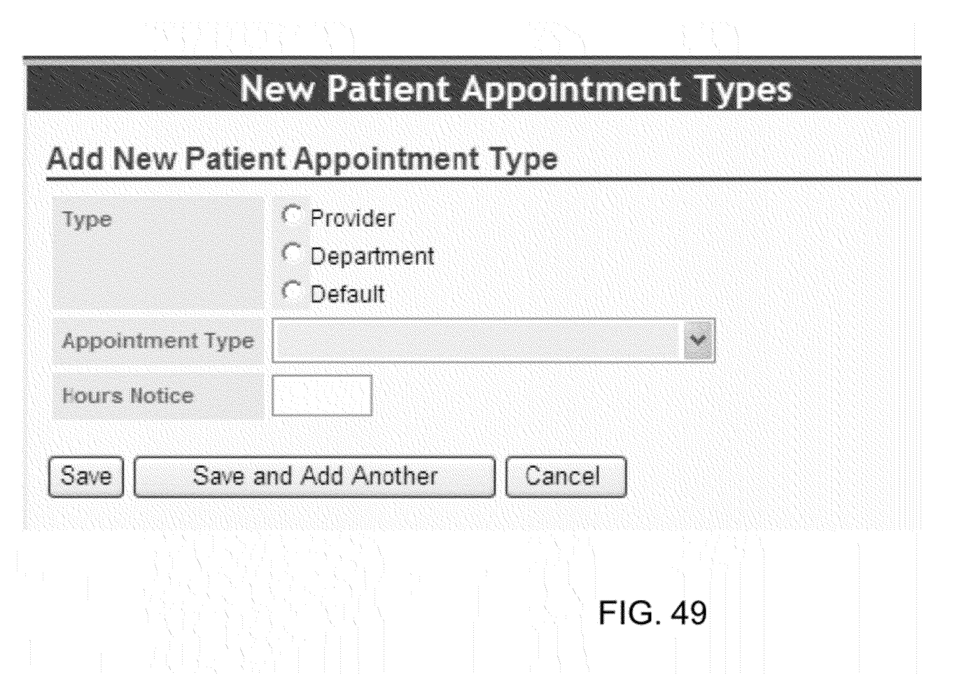

FIG. 49 illustrates a portion of user interface for creating a new appointment type in accordance with some embodiments of the invention. An administrator may interact with the user interface to indicate whether the appointment type is for a particular provider, for a particular department, or is a default appointment type. Other types of appointments not illustrated in FIG. 49 may also be used and embodiments of the invention are not limited in this respect. In some embodiments each department at a medical practice may only be associated with one appointment type, whereas in other embodiments, a single department may be associated with multiple appointment types. Other configuration options including, but not limited to, specifying an amount of time in advance of the appointment that a patient may schedule an appointment, may also be specified by an administrator of the medical practice to create a new appointment type.

One or more appointment types that have been created previously for a medical practice may be modified and the modified appointment type(s) may be saved as schedule configuration information stored by practice management system 100. In some embodiments, modified appointment types may not affect previously scheduled appointment timeslots. For example, if an appointment type had previously been configured to not require a cancellation reason, modifying the appointment type to require a cancellation reason may not affect the existing appointments having the appointment type, but may affect appointments of that appointment type that are newly scheduled following the modification. In other embodiments, an administrator may apply the modified configuration for the appointment type to all existing and new appointments having the appointment type. Although creating and modifying appointment types has been discussed with regard to portions of a user interface that include user interface elements such as drop down menus and text boxes, it should be appreciated that any suitable type of user interface may be used.

After at least one appointment type has been created, an administrator at the medical practice may associate one or more timeslots with the at least one appointment type to facilitate patient scheduling. For example, an administrator at a medical practice may associate timeslots with appointment types using an interactive calendar page that enables the administrator to specify on the calendar which timeslots are associated with which types of appointments. The administrator may match appointment types with timeslots by specifying, for example, duration of the timeslot, and day(s) of the week, time(s) during the day, etc. during which the appointment type is available for scheduling by users of the medical practice, live operators, and/or patients via web portal 230. In some embodiments, multiple appointment types may be associated with a single timeslot, whereas in other embodiments each timeslot may be associated with only one appointment type. By interacting with such an interactive calendar, the administrator may create, delete, or modify timeslots with which to associate particular appointment types. Although an interactive calendar page is one exemplary way to allow administrators of a medical practice to associate timeslots with appointment types, other user interfaces including, but not limited to, an interactive user interface with dropdown menus, text boxes, and/or any other type of suitable user interface element may alternatively be used.

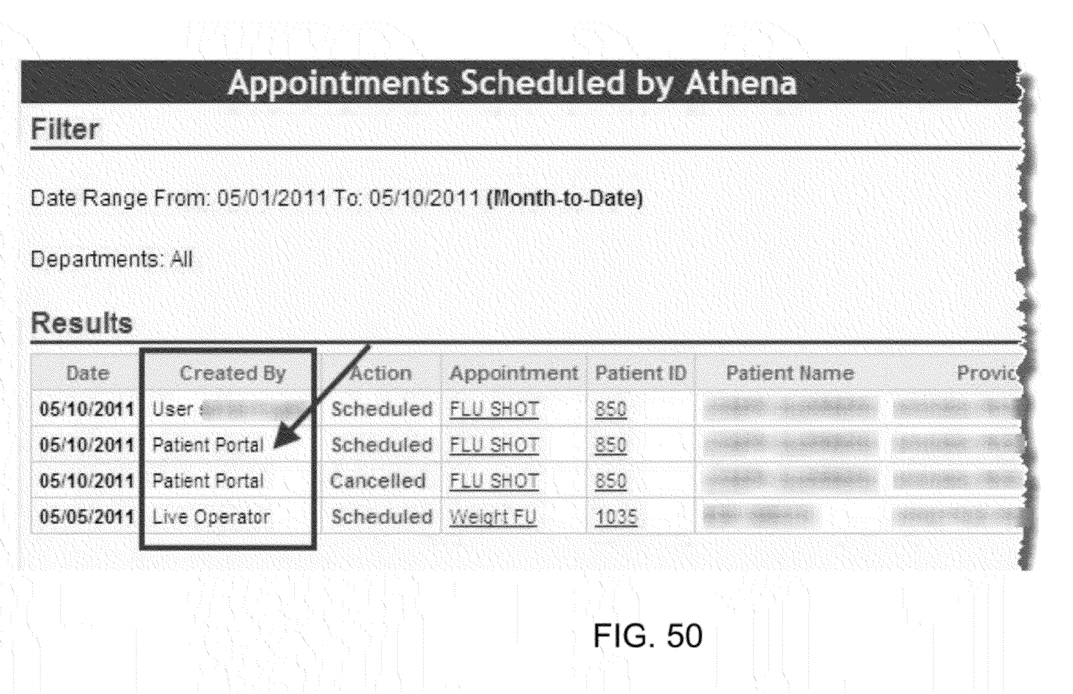

In accordance with some embodiments, a user of practice management system 100, such as an administrator at a medical practice, may generate a report of appointments for the medical practice stored by a scheduling component of the practice management system. FIG. 50 illustrates an exemplary report page describing appointments for a medical practice. To generate the report, the user may specify one or more search parameters including, but not limited to, a date range and which department at the medical practice the appointments are associated with. In response to receiving a request to generate a report, a scheduling component of practice management system 100 may be searched to identify all appointments that meet the search criteria and the matching appointments may be displayed to the user that initiated the request, as illustrated in FIG. 50.

As discussed above, in some embodiments, an appointment at a medical practice may be scheduled, rescheduled, or canceled in at least three ways. The patient may contact staff at the medical practice directly to schedule the appointment. An example of this is when a patient schedules a follow-up appointment prior to leaving the medical practice at a prior appointment. When an appointment is created by staff at the medical practice, an identifier for the staff member who scheduled the appointment may be indicated in the report as illustrated in FIG. 50. Another way to schedule an appointment is using an interactive scheduling component associated with web portal 230, as described above. As shown in FIG. 50, such appointments may be identified as “Patient Portal” or by using any other suitable indicator identifying that the patient scheduled the appointment using web portal 230. Additionally, some users may prefer to speak with a live operator (e.g., a user not at the medical practice) to schedule an appointment rather than scheduling the appointment using web portal 230. Instances of scheduled appointments created or modified by a live operator may also be indicated in a report page as shown in FIG. 50. Although only three ways have been discussed herein for scheduling an appointment using practice management system 100, it should be appreciated that other ways to schedule an appointment are also possible. For example, in some embodiments a patient may schedule an appointment using a text-based message or a telephone-based interaction without using web portal 230, and embodiments of the invention are not limited in the particular manner in which scheduled appointments associated with a practice management system are created or modified.

Other information about appointments including, but not limited to, appointment types, patient identifiers, patient names, and provider names may also be included in a scheduling report, as illustrated in FIG. 50. Additionally, whether the status of the appointment is scheduled or cancelled may also be shown. Although the exemplary report shown in FIG. 50 is illustrated in the form of a table with entries for each of the appointments matching the search criteria, it should be appreciated that appointment reports may be displayed in any other suitable way including, but not limited to, presenting the report results on a calendar or some other portion of a user interface.

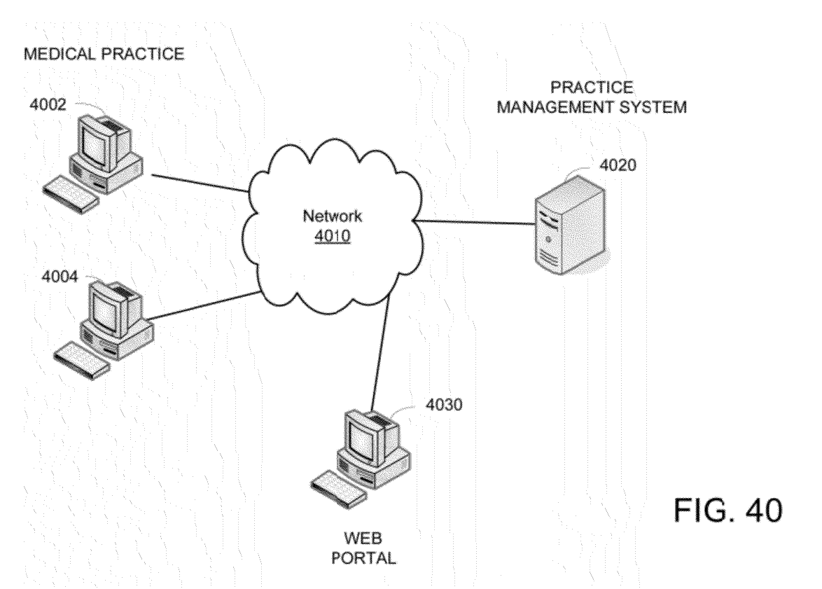

FIG. 40 illustrates an exemplary networked system on which some embodiments of the invention may be employed. Networked computers 4002 and 4004 located at a medical practice, web portal client computer 4030, and computer 4020 located at a location associated with a practice management system are shown connected to a network 4010. Network 4010 may be any type of local or remote network including, for example, a local area network (LAN) or a wide area network (WAN) such as the Internet. In the example of FIG. 40, two networked computers and one web portal client computer are shown. However, it should be appreciated that network 4010 may interconnect any number of computers of various types and the networked system of FIG. 40 is provided merely for illustrative purposes. For example, computer 4020 may be connected via network 4010 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of scheduling an appointment for a first patient of a medical practice associated with a practice management system, the method comprising:
receiving a request from the first patient of the medical practice to schedule the appointment;
searching a current schedule for appointments at the medical practice for available timeslots to schedule the appointment, wherein the current schedule is stored by a scheduling component of the practice management system;
presenting on a user interface, the available timeslots returned from the search;
receiving a selection of one of the available timeslots; and
updating, with at least one processor, the current schedule for appointments at the medical practice in response to receiving the selection of one of the available timeslots.

2. The method of claim 1, further comprising:
sending an automated message to the first patient, wherein the automated message includes a recommendation for the first patient to schedule the appointment; and
wherein receiving the request from the first patient comprises receiving the request from the first patient in response to sending the automated message.

3. The method of claim 1, wherein searching the current schedule comprises:
determining at least one attribute associated with the request; and
searching the current schedule based, at least in part, on scheduling configuration information stored by the practice management system, wherein the scheduling configuration information used for searching the current schedule is determined based, at least in part, on the at least one attribute associated with the request.

4. The method of claim 1, further comprising:
determining whether the request to schedule the appointment comprises a request to reschedule an existing appointment; and
cancelling, in response to determining that the request comprises a request to reschedule an existing appointment, the existing appointment.

5. The method of claim 4, further comprising:
sending an automated message to a second patient of the medical practice in response to cancelling the existing appointment, wherein the automated message includes a recommendation for the second patient to schedule an appointment during a timeslot associated with the cancelled appointment.

6. The method of claim 5, further comprising:
receiving a request from the second patient to schedule an appointment during the timeslot associated with the cancelled appointment; and
updating the current schedule for appointments at the medical practice to schedule the appointment for the second patient during the timeslot associated with the cancelled appointment, wherein the updating is performed based, at least in part, on the request received from the second patient.

7. The method of claim 1, further comprising:
prompting the first patient to provide confirmation prior to updating the current schedule for appointments at the medical practice;
receiving confirmation from the first patient to schedule the appointment; and
updating the current schedule for appointments at the medical practice in response to receiving the confirmation.

8. The method of claim 1, wherein presenting the available timeslots returned from the search comprises presenting the available timeslots on an interactive scheduling calendar with which the first patient may interact to select one of the available timeslots.

9. The method of claim 1, wherein the request to schedule the appointment is received via a web-based portal provided by the practice management system.

10. The method of claim 1, wherein at least a portion of the current schedule for appointments at the medical practice is accessible via a web-based interface to at least one user at the medical practice and the first patient.

11. A computer system including at least one computer configured to host a practice management system, the practice management system comprising:
a scheduling component, wherein the scheduling component is configured to store a current schedule for scheduling appointments at a medical practice, wherein the current schedule is associated with a plurality of appointment attributes configured by an administrator at the medical practice; and
at least one processor programmed to provide a web-based user interface, wherein the web-based user interface is configured to enable a first patient of the medical practice to schedule an appointment at the medical practice without sending information to the medical practice indicating preferred appointment times.

12. The computer system of claim 11, wherein the at least one processor is further programmed to:
receive a request from the first patient of the medical practice to schedule the appointment; and
update the current schedule for appointments at the medical practice in response to receiving the request.

13. The computer system of claim 11, further comprising:
a communications management component configured to send an automated message to the first patient, wherein the automated message includes a recommendation to schedule the appointment; and
wherein the request from the first patient is received in response to sending the automated message to the first patient.

14. The computer system of claim 11, wherein the web-based user interface is further configured to enable an administrator at the medical practice to specify configuration information for at least one appointment attribute for the medical practice;
wherein the at least one processor is further programmed to:
receive the configuration information for the at least one appointment attribute; and
store the received configuration information as scheduling configuration information for the medical practice.

15. The computer system of claim 14, wherein the received configuration information includes information associating the at least one appointment attribute with one or more timeslots of the current schedule for scheduling appointments at the medical practice; and
wherein the at least one processor is further programmed to update the current schedule for scheduling appointments at the medical practice based, at least in part, on the received configuration information.

16. The computer system of claim 11, wherein the plurality of appointment attributes includes a generic appointment type for which any type of appointment at the medical practice may be scheduled.

17. The computer system of claim 11, wherein the at least one processor is further programmed to display on the web-based user interface, at least one available timeslot for scheduling the appointment;
wherein the at least one available timeslot is determined based, at least in part, on scheduling configuration information stored by the practice management system; and
wherein the scheduling configuration information indicates which timeslots of the current schedule for scheduling appointments at the medical practice are available for scheduling the appointment.

18. The computer system of claim 11, wherein the plurality of appointment attributes are selected from the group consisting of: at least one appointment type, at least one provider, and at least one department.

19. The computer system of claim 11, wherein the at least one processor is further programmed to:
receive a request to generate a report for at least one appointment associated with the medical practice, wherein the request includes at least one search criterion for generating the report;
search the current schedule for the at least one appointment at the medical practice based, at least in part, on the at least one search criterion in the request; and
display, on the web-based user interface the report, wherein the report includes at least one appointment returned as results of the search.

20. At least one computer-readable medium encoded with a plurality of instructions that, when executed by a computer, perform a method of scheduling an appointment for a first patient of a medical practice associated with a practice management system, the method comprising:
receiving a request from the first patient of the medical practice to schedule the appointment;
searching a current schedule for appointments at the medical practice for available timeslots to schedule the appointment, wherein the current schedule is stored by a scheduling component of the practice management system;
presenting on a user interface, the available timeslots returned from the search;
receiving a selection of one of the available timeslots; and
updating the current schedule for appointments at the medical practice in response to receiving the selection of one of the available timeslots.
